(19) United States
(12) Patent Application Publication
(10) Pub. No.: US 2007/0211232 A1
(43) Pub. Date: Sep. 13, 2007

(54) Thermophoretic Techniques for Protecting Reticles from Contaminants

(76) Inventors: Alton Hugh Phillips, East Palo Alto, CA (US); Michael R. Sogard, Menlo Park, CA (US); Douglas C. Watson, Campbell, CA (US); Keiichi Tanaka, Saitama (JP)

Correspondence Address: BEYER WEAVER LLP, P.O. BOX 70250, OAKLAND, CA, 94612-0250, US

(21) Appl. No.: 10/578,752

(22) PCT Filed: Nov. 10, 2004
(86) PCT No.: PCT/US04/37542

§ 371 Date: Dec. 27, 2006

Related U.S. Application Data
(60) Provisional application No. 60/518,862, filed on Nov. 10, 2003.
(60) Provisional application No. 60/531,129, filed on Dec. 18, 2003.

(51) Int. Cl. G03B 27/52

(52) U.S. Cl. 355/30; 355/75; 355/72

(57) ABSTRACT

Thermophoresis within lithography systems for protecting reticles from contaminants (e.g., floating particles). Generally, thermophoretic protection is implemented by maintaining the reticle at a higher temperature than its surrounding environment. Thermophoretic protection can be maintained throughout a reticle's use in a lithography system. For example, a reticle can be thermophoretically protected while in storage, through various stages of transportation via a reticle handler (also referred to as an end-effector), to its period of use while attached to a reticle chuck.

### FIELD OF THE INVENTION

The present invention relates generally to photolithography systems, and more specifically to thermophoretic techniques for protecting reticles from contaminants.

### BACKGROUND

A lithography system commonly uses an illumination source, optics, and wafer and reticle stages to transfer patterned images from a reticle to a wafer. Throughout an entire process of storage, handling, and use, a reticle must be kept clean of particles that can interfere with the imaging process. Reticles in conventional lithography systems are protected from particles by a clear faceplate called a pellicle (which remains permanently attached to the reticle). Particles that fall on the pellicle are outside of the depth of focus of the lithography system and do not interfere with the imaging process. Moreover, the pellicle can be periodically cleaned without damaging the reticle.

However, in next generation lithography (NGL) systems, for example, extreme ultraviolet lithography (EUVL) systems, a pellicle cannot be used as it absorbs much of the illumination. Therefore, extra care must be taken to ensure that particles do not migrate to the reticle. Also, in EUVL the reticle must be kept very flat when attached to the reticle stage chuck. Therefore, it is also important to prevent relatively large particles from migrating to the backside of the reticle, which is its chucking surface.

A reticle handling system is used to transfer a reticle between the reticle stage and a reticle storage container (a.k.a. a pod). Reticle handling systems can be designed to reduce reticle contamination during handling processes. For example, a reticle handling system can be designed to minimize the number of contact events with the reticle, which reduces the likelihood of generating particles during contact at or near the reticle. A reticle handling system should not only protect the reticle from particles during handling, but should also handle the reticle in an efficient manner to improve system productivity. A reticle handling system should also be as compact as possible to reduce a system footprint to reduce the cost of ownership for a customer.

It should also be noted that where conventional lithography could be achieved in an atmospheric pressure environment, EUVL must be performed in a vacuum environment to reduce optical beam absorption by ambient gases. Therefore, the reticle should be handled in a vacuum environment and should be transferred from its storage container (which is at an atmospheric pressure) to a vacuum pressure environment within the lithography tool. EUVL systems therefore pose even greater challenges to minimizing contamination of reticles.

In view of the foregoing, there are continuing efforts to provide improved techniques for minimizing reticle contamination in lithography systems.

### BRIEF SUMMARY OF THE INVENTION

The present invention is directed to the use of thermophoresis within lithography systems to protect reticles from contaminants (e.g., floating particles). Generally, thermophoretic protection is implemented by maintaining the reticle at a higher temperature than its surrounding environment. Thermophoretic protection can be maintained throughout a reticle's use in a lithography system. For example, a reticle can be thermophoretically protected while in storage, through various stages of transportation via a reticle handler (also referred to as an end-effector), to its period of use while attached to a reticle chuck. Preferably, a gaseous environment at pressures ranging from atmospheric down to a few tens of millitorr is provided for thermophoresis effects. In addition to using thermophoresis throughout an entire lithographic system, thermopheretic protection can be used in just one or select stages of a lithographic system.

One embodiment of the present invention pertains to an extreme ultraviolet lithography system that includes at least a reticle having a top and a bottom surface, a plurality of chambers for storing or utilizing the reticle, and a top plate and a bottom plate that are proximate to the top and bottom surface of the reticle, respectively. The top and bottom plate are maintained at a lower temperature than a temperature of the reticle, wherein the reticle is thermophoretically protected from contamination.

Another embodiment of the present invention pertains to a reticle handler that includes at least a support arm that supports a top plate and a bottom plate in substantially coplanar relative positions such that the reticle can be supported between the top plate and the bottom plate. The top and bottom plate are maintained at a lower temperature than a temperature of the reticle, wherein the reticle handler transports the reticle while being in between the top plate and the bottom plate so that the reticle is thermophoretically protected from contaminants during transit.

Another embodiment of the present invention pertains to a pod that includes at least a top plate, a bottom plate, and a cover. The top plate and the bottom plate are suspended in a substantially coplanar orientation relative to each other such that the reticle can be positioned between the top plate and the bottom plate. The top plate and the bottom plate are maintained at a lower temperature than a temperature of the reticle so that the reticle is thermophoretically protected from contamination. The cover joins together with the bottom plate to enclose the reticle and the top plate within the top cover and the bottom plate.

Another embodiment of the present invention pertains to a lithography system that includes at least a reticle chamber and an optics chamber. The reticle chamber contains a reticle wherein the reticle is maintained at a reticle temperature. The reticle chamber is maintained at a temperature that is lower than the reticle temperature such that the reticle is thermophoretically protected from contamination. The optics chamber is connected to the reticle chamber through a passageway. The optics chamber contains at least one optical lens for directing ultraviolet radiation through the passageway and towards the reticle.

Another embodiment of the present invention pertains to a lithography system that includes at least a pod, a loadlock chamber, and a lid. The pod is suitable for containing a reticle. The loadlock chamber has a first surface that contains a first gate valve, wherein the pod is attached to the first surface of the loadlock chamber. The first gate valve allows the reticle to be transferred from the pod into the loadlock chamber. And the lid seals the pod between the lid and the first surface of the loadlock chamber such that a low pressure environment can be formed around the pod.

Another embodiment of the present invention pertains to a lithography system that includes at least an illumination source, an optical system, a reticle stage, a working stage arranged to retain a workpiece, an enclosure that surrounds at least a portion of the working stage, the enclosure having a sealing surface, a reticle having a top and a bottom surface and a top plate and a bottom plate that are proximate to the top and bottom surface of the reticle, respectively. The top and bottom plate are maintained at a lower temperature than a temperature of the reticle, wherein the reticle is thermophoretically protected from contamination.

These and other features and advantages of the present invention will be presented in more detail in the following specification of the invention and the accompanying figures, which illustrate by way of example the principles of the invention.

### BRIEF DESCRIPTION OF THE DRAWINGS

The invention, together with further advantages thereof, may best be understood by reference to the following description taken in conjunction with the accompanying drawings in which:

FIG. 1A illustrates a reticle pod according to one embodiment of the present invention.

FIG. 1B illustrates the reticle pod of FIG. 1A after the cover and filter have been removed from the bottom plate.

FIG. 2 illustrates a perspective view of a portion of a reticle pod according to an alternative embodiment of the present invention.

FIG. 3 illustrates a reticle handler according to one embodiment of the present invention.

FIGS. 4A and 4B illustrate the reticle handler of FIG. 3 in the process of removing a reticle from a reticle pod according to one embodiment of the present invention.

FIG. 5 shows one technique for cooling the end-effector of the reticle handler.

FIGS. 6A-6C illustrate the process of loading a reticle onto a reticle chuck using a reticle handler according to one embodiment of the present invention.

FIGS. 7A-7F illustrate a reticle handler in the process of attaching a reticle to a reticle chuck according to an alternative embodiment of the present invention.

FIG. 8 illustrates a side plan, cross-sectional view of a reticle library according to one embodiment of the present invention.

FIG. 9A illustrates a reticle (RS) chamber and a projection optics (PO) chamber according to one embodiment of the present invention.

FIG. 9B illustrates the RS chamber and the PO chamber while an end-effector enters the RS chamber to remove the reticle.

FIGS. 10A-10C illustrate a reticle depod and interlock (DI) unit according to one embodiment of the present invention.

FIG. 11 illustrates a cross-sectional view of a reticle pod that includes a removable cover according to one embodiment of the present invention.

FIG. 12 illustrates a cross-sectional view of an interlock chamber that includes a removable cover according to one embodiment of the present invention.

FIG. 13 illustrates a reticle library that includes a removable cover according to one embodiment of the present invention.

FIG. 14 illustrates a cross-sectional view of a reticle pre-alignment system that includes a removable cover according to one embodiment of the present invention.

FIG. 15 illustrates a reticle stage (RS) chamber and a projection optics (PO) chamber according to one embodiment of the present invention.

FIG. 16 shows an EUV (or soft-X-ray SXR) system, including the EUV mirror of this invention as described above.

FIG. 17 illustrates a process for fabricating semiconductor devices using the above-described systems.

FIG. 18 illustrates a detailed flowchart example of the above-mentioned step 1004 in the case of fabricating semiconductor devices.

### DETAILED DESCRIPTION OF THE INVENTION

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known operations have not been described in detail so not to unnecessarily obscure the present invention.

The present invention pertains to the use of the thermophoretic physical phenomenon within lithography systems to protect reticles from contaminants (e.g., floating particles). Thermophoresis is the physical phenomenon where particles move through a gas having a temperature gradient from a higher temperature region towards a lower temperature region. The particles move through the temperature gradient due to collisions with the molecules in the gas. Gas molecules in the higher temperature region have more momentum than molecules in the lower temperature region. Therefore the net momentum transfer to the particles during collisions will drive the particles towards the lower temperature region and away from the higher temperature region. It is noted that a minimum amount of gas pressure is required for a thermophoretic force region to effectively protect a component, such as a reticle, from contamination. In some embodiments, a low vacuum provides sufficient gas pressure.

Generally, thermophoretic protection is implemented by maintaining the reticle at a higher temperature than its surrounding environment to establish a temperature gradient in the gas surrounding the reticle. In one embodiment, plates that are at a relatively low temperature are positioned proximate to the top and bottom surfaces of a higher temperature reticle. Thermophoretic protection can be maintained throughout a reticle's use in a lithography system. For example, a reticle can be thermophoretically protected while in storage, through various stages of transportation via a reticle handler (also referred to as an end-effector), to its period of use while attached to a reticle chuck. The following description will explain various implementations of thermophoretic reticle protection. However, it should be noted that the thermophoretic reticle protection techniques can be implemented in various stages of a reticle's use in a lithography system.

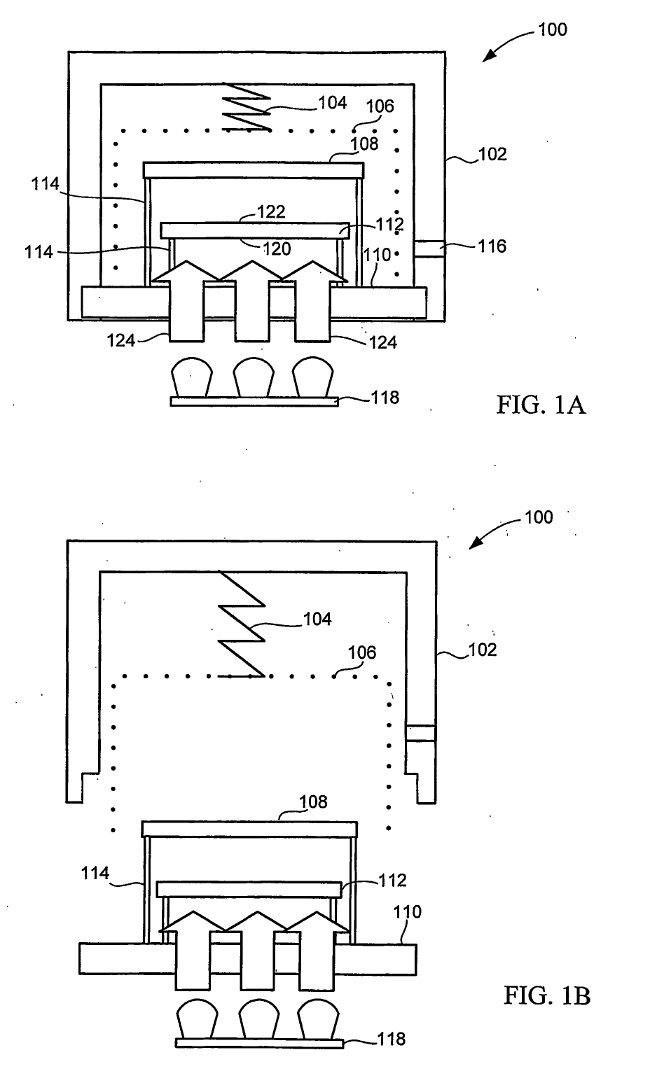

FIG. 1A illustrates a reticle pod 100 according to one embodiment of the present invention. The reticle pod 100 includes a cover 102, a filter spring 104, a filter 106, a top plate 108, a bottom plate 110, a reticle 112, support stems 114, a pressure equalization port 116, and a light source 118.

Support stems 114 support the reticle 112 in a position between the top plate 108 and the bottom plate 110. The support stems 114 also support the top plate 108 above the bottom plate 110. The cover 102 encloses the top plate 108, reticle 112, and the bottom plate 110 by setting upon the bottom plate 110. The cover 102 has a rim that connects with the bottom plate 110 to seal the cover 102 within. The cover 102 serves to protect the reticle 112 from contaminants and from structural damage. The cover 102 has a pressure equalization port 116 that allows for the pressure inside and outside of the cover to equalize.

The filter spring 104 is connected to the inside, top surface of the cover 102 and presses down upon the filter 106 to keep the filter 106 in firm contact with the bottom plate 110. The downward pressure helps maintain a seal between the filter 106 and the bottom plate 110 that minimizes contaminant flow between the inside and the outside of the filter 106. The filter 106 is a cover-shaped structure that fits over the top plate 108 and reticle 112, and sits on top of the bottom plate 110. The filter 106 is made of a filter material designed to keeps particles from reaching the reticle 112, especially the chucking surface 122 of the reticle 112 and the patterned surface 120 of the reticle 112. The filter 106 keeps particles off of the rectile 112 during pressure changes between inside and outside of the pod when particles tend to become agitated and swirl around the inside of the pod 100. The light source 118 directs light upon reticle 112 through the bottom plate 110, which is transparent, in order to maintain reticle 112 at a temperature that is above that of the surrounding structures.

In one embodiment, reticle 112 is used in an extreme ultraviolet lithography system. Typically, reticle 112 has a patterned surface 120 and a chucking surface 122. In one embodiment, reticle 112 can be formed of glass or quartz with patterning on the patterned surface 120 being formed of various materials suitable for either absorbing or reflecting EUV radiation. The patterned surface 120 is designed to reflect extreme ultraviolet light from a light source onto a substrate to be patterned. The chucking surface 122 of the reticle 112 is the surface that will be attached to a reticle stage, which supports the reticle 112 during an exposure process. It is important to keep the patterned surface 120 of the reticle 112 free from contaminants so that a pattern can be exposed onto the substrate without aberrations and defects. It is also important to keep the chucking surface 122 clean so that the reticle 112 can be attached to the reticle chuck without contaminants that may cause the reticle 112 to deform or to sit upon the chuck at an incorrect angle. As will be described in more detail below, reticle 112 is protected from contaminants through thermophoresis by maintaining reticle 112 at a higher temperature than a temperature of the surrounding structures.

The top plate 108 and the bottom plate 110 are cooled to a temperature that is lower than that of the reticle 112 to provide a thermophoretic effect around the reticle 112. The top plate 108 and the bottom plate 110 can be cooled through various techniques such as, but not limited to, conduction, convection, and radiation. The bottom plate 110 is transparent so that the reticle 112 can be heated by light from the light source 118. Directional arrows 124 represent the light that is directed at the reticle 112. In some embodiments, the cooling of the bottom plate 110 should be strong enough to compensate for any heat that is absorbed from the light from the light source 118. The light source 118 can be of various types that include, but are not limited to, incandescent, infrared, and light emitting diodes.

The top plate 108 creates a thermophoretic effect above the top surface 122 of the reticle 112 so that contaminants, such as free-floating particles, are moved away from the reticle 112. The bottom plate 110 creates a thermophoretic effect below the patterned surface 120 of the reticle 112. In the embodiment shown, the top plate 108 and the bottom plate 110 are substantially flat, plate-like structures. The surface area of the plates is typically approximately the same size or larger than the reticle 112 so that a thermophoretic force region can be created around the entire reticle 112.

In one embodiment, the reticle is maintained at approximately room temperature by the light source 118 while the top plate 108 and the bottom plate 110 are maintained at a lower temperature. In some embodiments, the top plate 108 and the bottom plate 110 are maintained at a temperature that is approximately 5-10° C. lower than the reticle 112. Such a temperature difference can provide a thermophoretic effect that is sufficient for keeping contaminants away from the reticle 112 without excessive energy requirements for cooling and/or heating. In one embodiment, the top and the bottom plates 108 and 110 are maintained at 22° C. while the reticle 112 is maintained at 27-32° C.

In some embodiments, other various structures surrounding the reticle 112 can also be maintained at a temperature that is lower than that of the reticle 112 to create a thermophoretic effect. For example, the stems 114 and the cover 102 can also be cooled to increase the thermophoretic effect surrounding the reticle 112. The structures surrounding the reticle 112 can be cooled through various techniques that involve conduction, convection, and/or radiation.

For effective thermophoretic protection, the reticle 112 should be separated from adjacent, cold structures by at least the mean free path of gas molecules, which is the average distance molecules travel before hitting another molecule. Since the mean free path is extremely small, in practicality, the separation between the reticle 112 and surrounding structures should be large enough to allow for a reticle to be conveniently handled and transported. In one instance, the separation between the reticle 112 and the top and the bottom plates 108 and 110 should be large enough to allow a reticle handler to grab, insert, and remove the reticle 112 from the pod 100.

FIG. 1B illustrates the reticle pod 100 of FIG. 1A after the cover 102 and filter 106 have been removed from the bottom plate 110. As the cover 102 is removed, the filter spring 104 lifts the filter 106 off of the bottom plate 110. The cover 102 is removed so that the reticle 112 can be removed from pod 100 and transported into a lithography system for use. The thermophoretic effect between the top plate 108, the bottom plate 110, and the reticle 112 continues to protect the reticle 112 from contamination during and after the cover 102 is removed.

Support stems 114, which extend from bottom plate 110, support the reticle 112 in a position that is in between the bottom plate 110 and the top plate 108. Another set of support stems 114 support the top plate 108 over the reticle 112. Support stems 114 can be formed of materials that have high thermal resistance. Support stems 114 also have small tips that have correspondingly small contact areas that support the reticle 112. The small tips minimize the amount of heat transferred through the support stems 114 and from the reticle 112. Support stems 114 should also be formed of a material that does not generate particles, for example, through contact with other structures such as the reticle. It is also a design goal of the present invention to minimize the amount of particles generated around the reticle 112.

In an alternative embodiment, the pod 100 has an onboard cooling device for cooling any or all of the top plate 108, bottom plate 110, the stems 114, and the cover 102. The cooling device can be battery operated or receive power from an external source. In some embodiments, a control system can also be added to the pod 100 to maintain the structures surrounding the reticle 112 at a temperature that is below that of the reticle 112.

In some embodiments, the reticle 112 can be heated by inductively heating the reticle coating. In this embodiment, the reticle 112 is coated with an electrically conductive material (i.e. chrome). An electrical conductor near the reticle 112 carrying an alternating current can be used to generate an alternating current within the conductive material. This transfer of power can be done across an air gap or vacuum gap without contact between the reticle 112 and the nearby conductor. The current flowing in the conductive material of the reticle 112 is converted to heat, as the conductive material has some finite electrical resistance.

In other embodiments, the reticle 112 can be heated by resistive heating of the reticle coating. In this embodiment, the reticle 112 is coated with an electrically conductive material (i.e. chrome). Supports 114 are made of a conductive material and are in electrical contact with the reticle conductive coating. In this configuration, a voltage difference between any supports 114 will establish a current flow in the conductive coating of the reticle 112. The current flowing in the conductive material of the reticle 112 will be converted to heat because the conductive material has a finite electrical resistance.

In alternative embodiments, the light source 118 can be substituted with alternative radiation sources.

In one embodiment, the cover 102 has a side opening for a reticle handler to enter into the pod 100.

In one embodiment, the bottom plate 110 and/or the top plate 108 can have extensions that are proximate to the side edges of the reticle 112. These extensions can also be cooled and thereby provide thermophoretic protection to the side edges of the reticle 112.

Some embodiments of the pod 100 do not include the filter 106 and the filter spring 104.

In one embodiment, the reticle 112 can be electrically grounded to the pod 100 to prevent the reticle 112 from attracting charged particles. Specifically, the reticle 112 can be grounded to any or all of the cover 102, the top plate 108, the bottom plate 110, or the filter 106.

In some embodiments, the support stems 114 are formed of a magnetic material and a magnetic field is created in the region surrounding the stem so that any particles that break away from the stem can be collected by the magnetic field. Particles can break away from the stems 114 due to coming in and out of contact with the reticle 112. The magnetic field can be designed to draw the magnetic particles away from the reticle. It should also be noted that other components within the pod 100 that come in and out of contact with other structures can also be formed of magnetic materials with an accompanying magnetic field imposed around the magnetic component to collect any particles that break away from the stem 114. For more details pertaining to controlling the flow of particles generated from magnetic components, refer to U.S. patent application Ser. No. 10/956,606, filed on Oct. 1, 2004, entitled, “Contact Material and System for Ultra-Clean Applications,” which is hereby incorporated by reference for all purposes.

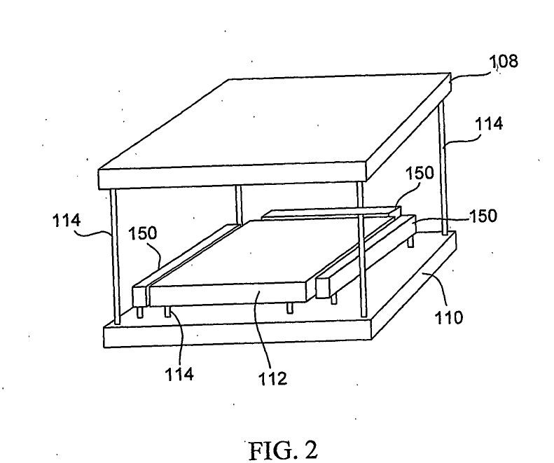

FIG. 2 illustrates a perspective view of a portion of a reticle pod according to an alternative embodiment of the present invention. Other components of the reticle pod, such as the cover, are not shown to more clearly illustrate certain aspects of the invention. The portion shown includes a bottom plate 110, a top plate 108, support stems 114, a reticle 112, and heating elements 150. Heating elements 150 are positioned about the side edges of reticle 112 to add heat to the reticle 112. Heating the reticle 112 maintains the thermophoretic effect between the reticle 112 and the surrounding components, such as the top plate 108 and the bottom plate 110. In one embodiment, the heating elements 150 are not placed in contact with the reticle 112 to reduce contamination of the reticle. The reticle 112 can thereby be heated by the heating elements 150 through radiation or convection. However, in other embodiments, the heating elements 150 can be placed in contact with the reticle 112 so that heat can be transmitted to the reticle 112 by conduction. Note that heating elements 150 are placed on three sides of the reticle 112 to allow a reticle handler to enter a pod and either insert or remove the reticle 112. In alternative embodiments, one or two heating elements 150 can also be used. Also, one embodiment can utilize heating elements 150 on all four edges of the reticle 112 so long as a reticle handler and the heating elements are designed to allow handling of the reticle 112. In another embodiment, the heating elements 150 may be replaced by arrays of optical fibers, which convey optical power from a laser or laser diode or laser diode array to the edges of the reticle 112.

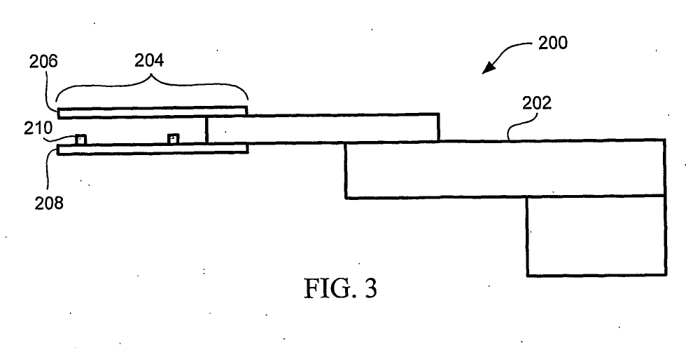

FIG. 3 illustrates a reticle handler 200 according to one embodiment of the present invention. The reticle handler 200 includes a robotic arm 202 that is connected to an end-effector 204. The robotic arm 202 is a mechanical arm having actuators for moving the arm and the end-effector 204 in various positions. The end-effector 204 includes a top plate 206 and a bottom plate 208 that are positioned in substantially coplanar relative positions. The bottom plate 208 has support stems 210 designed to support a reticle. The reticle handler 200 provides an electrically conductive path to the reticle so that the reticle 112 may be electrically grounded during handing.

The top plate 206 and the bottom plate 208 are maintained at a lower temperature than a reticle that is to be supported by the support stems 210. The top plate 206 and the bottom plate 208 thereby provide a thermophoretic force region around the reticle for protection from contaminants. As described earlier, the top plate 206 and the bottom plate 208 are flat, plate-like structures that have a surface area that is at least as large as the reticle 112 so that a thermophoretic force region is created around substantially all of the reticle. The top plate 206 and the bottom plate 208 have a thermal capacitance enabling them to remain at a low temperature for a sufficient amount of time to allow a reticle to be transported from one location to the next within a lithography system while providing thermophoretic protection of the reticle.

Robotic arm 202 can be made of various types of actuators, joints, and structural members. Robotic arm 202 should however be designed to minimize generation of particles during operation to maintain a contaminant-free environment during operation within a lithography system.

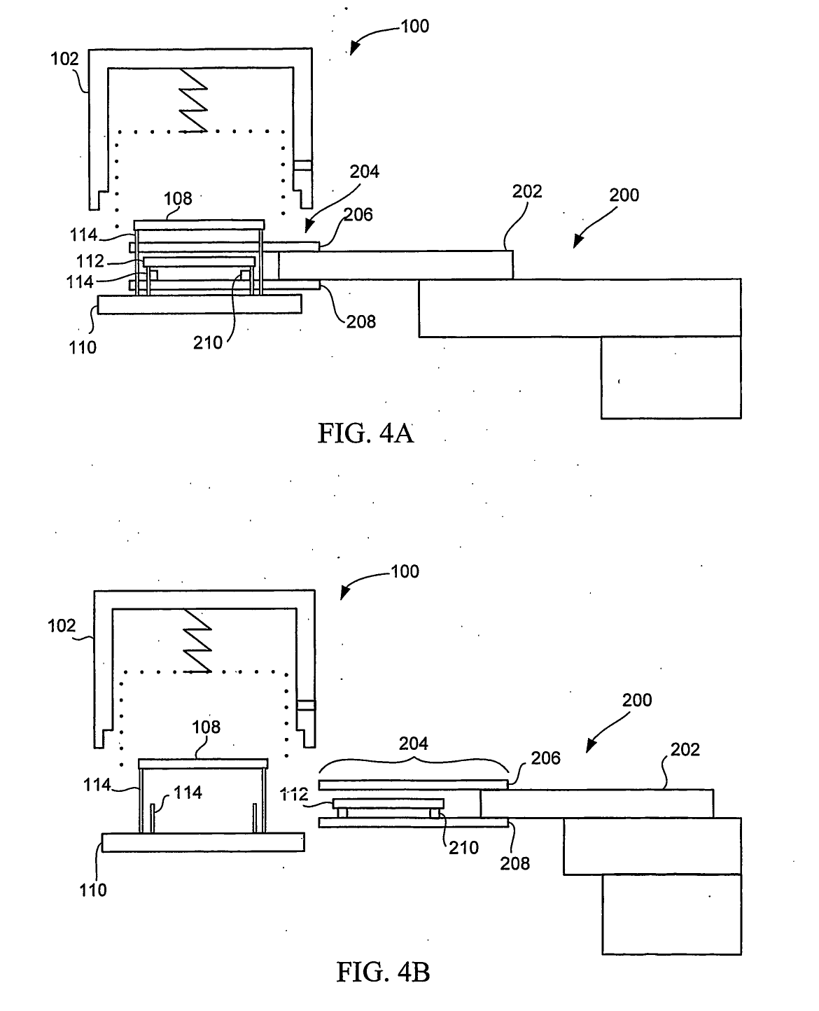

FIGS. 4A and 4B illustrate the reticle handler 200 of FIG. 3 in the process of removing a reticle 112 from a reticle pod 100 according to one embodiment of the present invention. In FIG. 4A, the reticle pod 100 has been opened wherein the cover 102 has been lifted off of the bottom plate 110. The robotic arm 202 of the reticle handler 200 has extended so that the end-effector 204 is inserted between the top plate 108 and the bottom plate 110. At the same time, the end-effector 204 is positioned around the reticle 112 in a ready position to lift the reticle 112 off of support stems 114. The bottom plate 208 can have slots that allow for the bottom plate 208 to fit around the support stems 114 that support the reticle 112.

FIG. 4B shows the reticle handler 200 after the end-effector 204 has picked up the reticle 112 and has removed the reticle 112 from the pod 100. The support stems 210 of the bottom plate 208 support the reticle 112 within the end-effector 204 so that the reticle 112 is supported between the top plate 206 and the bottom plate 208. The thermophoretic effect between the reticle 112 and the top plate 206 and the bottom plate 208 protect the reticle 112 from contaminants throughout a transportation process. The reticle handler 200 can move the reticle 112 between various locations within a lithography system. For example, the reticle handler 200 can move a reticle between any two of a loadlock chamber, a pre-alignment chamber, a storage library chamber, and a reticle stage chamber.

The thermophoretic force region around the reticle 112 is maintained throughout a typical transportation process without active cooling or heating processes. That is to say that the top plate 206 and the bottom plate 208 can remain sufficiently cool with respect to the reticle 112 to provide sufficient thermophoretic protection without requiring active cooling during transport of the reticle. One reason is that the time required to transport a reticle between locations within a lithography system is relatively short and within such a time period, the top and bottom plates will not rise in temperature a significant amount. During the same amount of time required for transportation, the reticle 112 will also not cool down from its relatively higher temperature any significant amount that would reduce the thermophoretic force region around the reticle 112. Therefore, no active heating of the reticle 112 is needed during a transportation process.

The reticle 112 and the top and bottom plates 206 and 208, respectively, can be heated and cooled as needed in between transportation processes. For instance, the reticle can be heated while, for example, in the reticle pod 100, within a storage library that is within the lithography system, or while it is on a reticle stage.

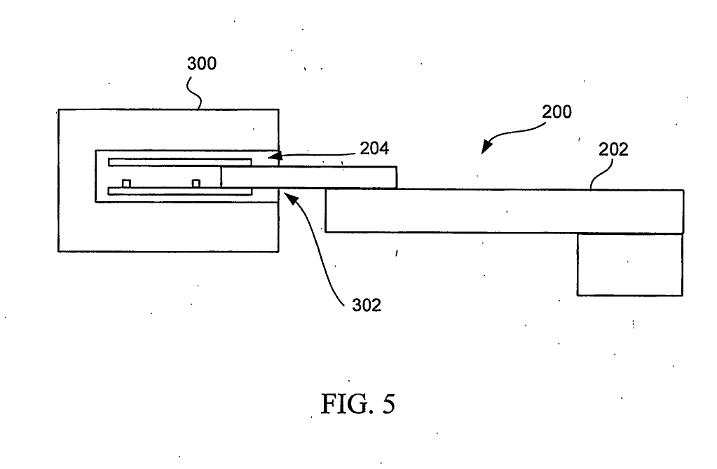

FIG. 5 shows one technique for cooling the end-effector 204 of the reticle handler 200. Specifically, FIG. 5 illustrates a side plan, cross-sectional view of a reticle handler 200 that is cooled by a cooling device 300. The cooling device 300 has a pocket 302 that receives the end-effector 204 of the reticle handler 200. The cooling device 300 has a cooling capability that cools the pocket 302 and thereby cools the end-effector 204. The cooling device 300 can cool the end-effector 204, for example, through conduction, convection, and radiation. The embodiment of FIG. 5 shows that the end-effector 204 does not come into contact with the pocket 302. However, in an alternative embodiment, the pocket 302 can come into contact with the end-effector 204 to cool the end-effector 204 through conduction.

In an alternative embodiment, additional cooling structures can extend from the inside surface of the pocket 302 to further cool the end-effector 204. For example, a cooling plate can extend from the inside surface of the pocket 302 into the slot between the top plate 108 and the bottom plate 110. The position of the cooling plate adds the capability to effectively cool the end-effector 204 from between the top plate 108 and the bottom plate 110. It should be understood that the pocket 302 can have various shapes for effectively cooling the end-effector 204.

In some embodiments, the reticle handler 300 can have an attached cooling device so that the end-effector 204 can be continually cooled during transportation processes, as well as during idle times.

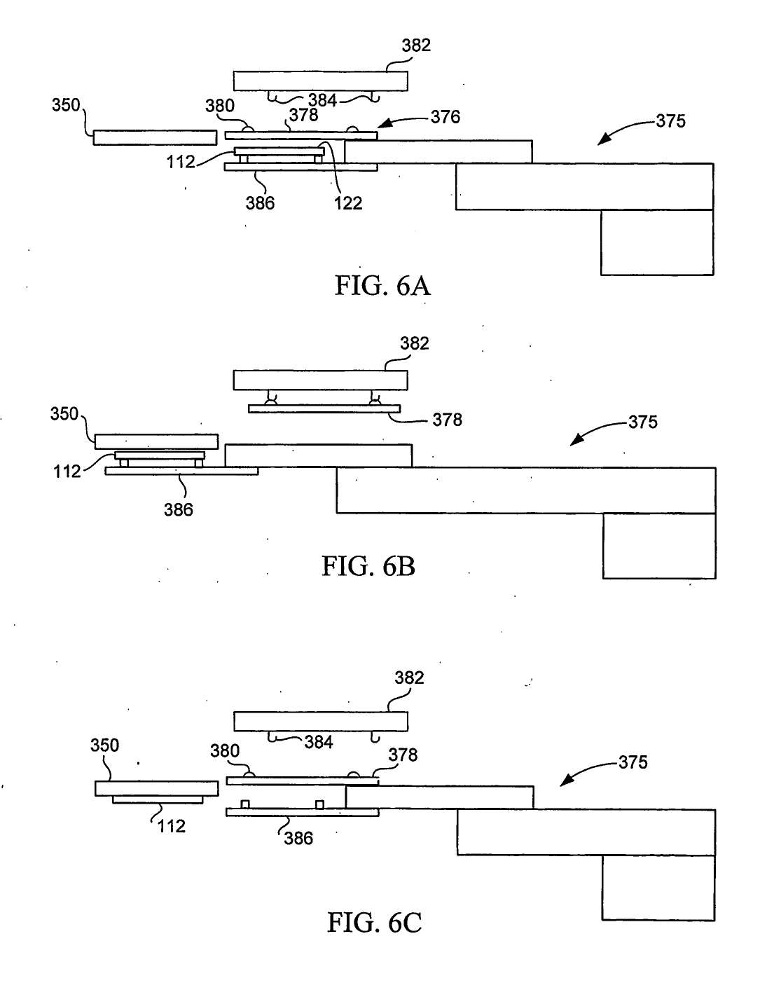

FIGS. 6A-6C illustrate the process of loading a reticle 112 onto a reticle chuck 350 using a reticle handler 375 according to one embodiment of the present invention. The end-effector 376 of the reticle handler 375 has a removable top plate 378 that allows the end-effector 376 to easily attach the reticle 112 onto the reticle chuck 350. The reticle chuck 350 receives and secures the chucking surface 122 of the reticle 112 so that the reticle can be positioned during a pattern exposure process. The top surface of the top plate 378 has support loops 380 that can be used to hang the top plate 378 upon a hanging structure 382. The hanging structure 382 has hooks 384 that can loop through the support loops 380 of the top plate 108 to support the top plate 378.

In FIG. 6A, the reticle handler 375 positions the end-effector 376 near the reticle chuck 350 prior to attaching the reticle 112 to the reticle chuck 350. In FIG. 6B, the reticle handler 375 goes through a motion that causes the top plate 378 to be hung by its support loops 380 upon the hooks 384 of the support structure 382. With the top plate 378 removed from the reticle handler 375, the chucking surface 122 of the reticle 112 is exposed and ready to be attached to the reticle chuck 350. Then the rest of the end-effector 376, which includes the bottom plate 386, and the reticle 112 are moved beneath the reticle chuck 350 so that the reticle 112 is attached to the reticle chuck 350.

As shown in FIG. 6C, after the reticle 112 is attached to the reticle chuck 350, the reticle handler 375 goes through a motion to pick up the top plate 378 from the support structure 382. The top plate 378 is then reattached to the end-effector 376. The process of removing and attaching the top plate 378 can be repeated when the reticle 112 is to be removed from the reticle chuck 350.

In alternative embodiments, various types of structures can be used by the support structure 382 for supporting the top plate 378. The support structure 382 can use various techniques for supporting the top plate 378. For example, the support structure 382 can support the top plate 378 through contact with the underside of the top plate 378, rather than its top surface, or it could make contact with one or more edges of the top plate 382. Embodiments with no moving parts are advantageous in that they minimize the generation of particles that can potentially contaminate the reticle 112.

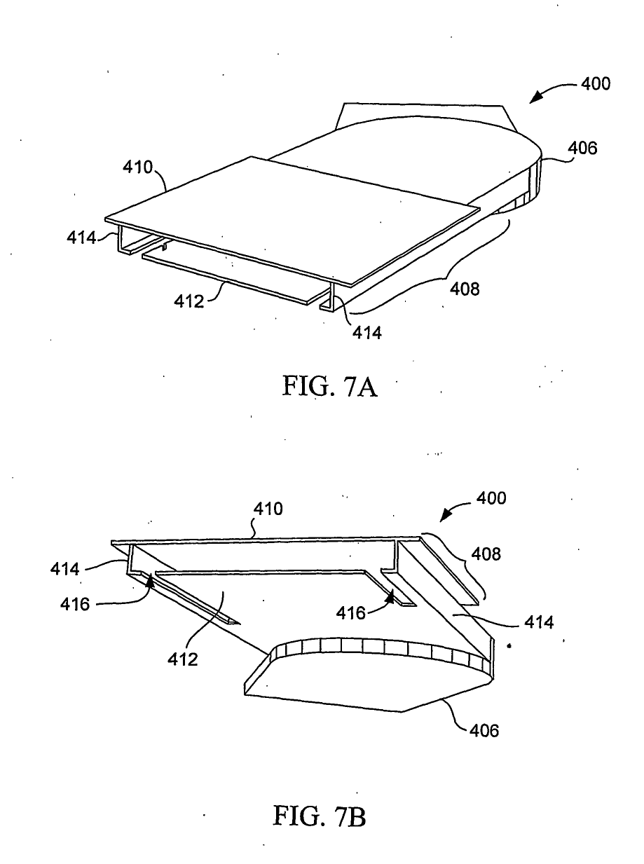

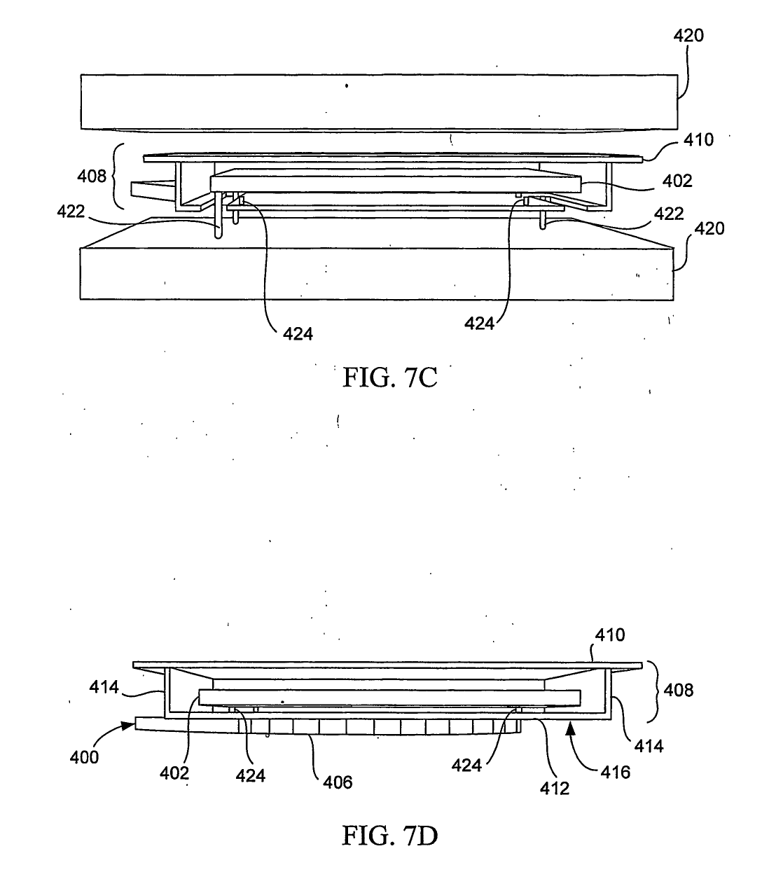

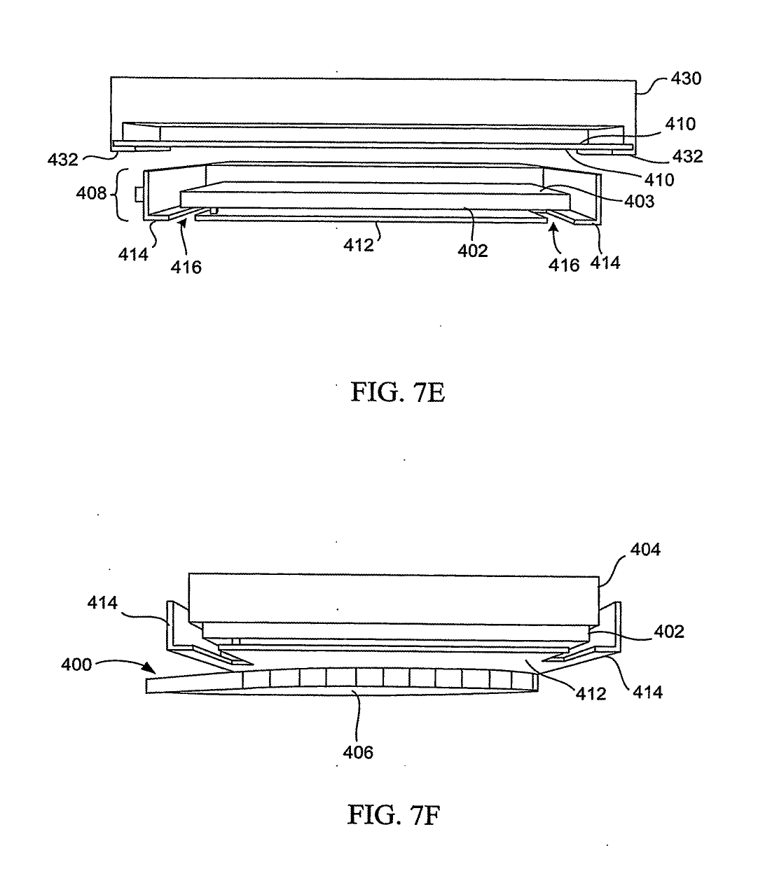

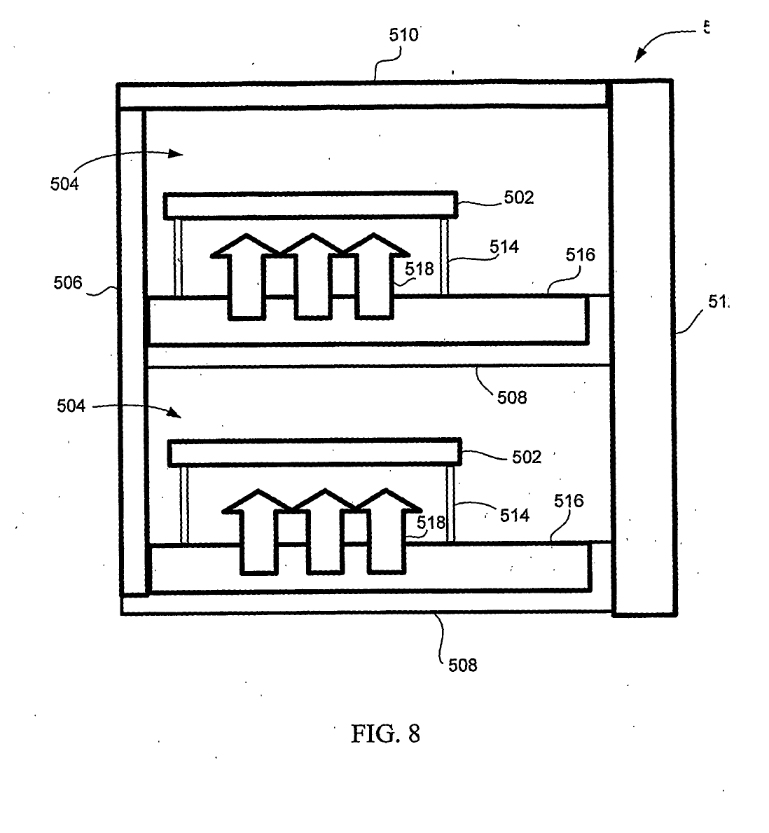

FIGS. 7A-7F illustrate a reticle handler 400 in the process of attaching a reticle 402 to a reticle chuck 404 according to an alternative embodiment of the present invention. FIG. 7A illustrates a top perspective view and FIG. 7B illustrates a bottom perspective view of the reticle handler 400, respectively. Reticle handler 400 includes a robotic arm 406 and an end-effector 408. The robotic arm 406 has a rotating joint that allows the end-effector 408 to be positioned in various positions along a horizontal plane. The robotic arm 406 typically will also have the ability to move the end-effector 408 along a vertical axis. The end-effector 408 is the end portion of the robotic arm 406 that includes a top plate 410, a bottom plate 412, and sidewalls 414. Slots 416 are formed between the bottom plate 412 and each of the sidewalls 414 so that the end-effector 408 can pick up the reticle 402 that is supported by support stems 422 of a reticle storage container (see FIG. 7C). The end-effector 408 is sized to pick up and transport the reticle 402. As discussed earlier, the end-effector 408 is maintained at a temperature that is below that of the reticle 402 so that a thermophoretic force region surrounds and protects the reticle 402 from contamination. The top plate 410, bottom plate 412, and the sidewalls 414 all create a thermophoretic force region that surrounds the reticle 402.

FIG. 7C shows a front perspective view of the reticle handler 400 as it is inserted into the space between to plates 420 of a reticle storage container, such as a reticle pod. The plates 420 of the reticle storage container are also maintained at a low relative temperature to thermophoretically protect the reticle 402 from contaminants. The end-effector 408 maneuvers so that the top plate 410, sidewalls 414, and the bottom plate 412 surround the reticle 412. The support stems 422 that support the reticle 402 above the lower plate 420 slide between the slots 416 of the end-effector 408. The end-effector 408 then rises so that the support stems 424, which extend from the bottom plate 412, pick the reticle 402 off of the support stems 422. FIG. 7D shows the end-effector 408 after it has picked up the reticle 402.

FIGS. 7E-7F illustrate the process of attaching the reticle 402 to a reticle chuck 404 using the reticle handler 400. In FIG. 7E, the reticle handler 400 maneuvers so that the top plate 410 is picked up and lifted off of the end-effector 408 by a support structure 430. Support ledges 432 extend from opposing sides of the support structure 430 to support the top plate 410 from its side edges. The reticle handler 400 can maneuver along a horizontal axis so that the top plate 410 slides beneath the support structure 430 and becomes supported by the support ledges 432. Afterwards, a chucking surface 403 of the reticle 402 is exposed and can be more easily attached to the reticle chuck 404.

FIG. 7F illustrates a front perspective view of the reticle handler 400 as it attaches the reticle 402 to the reticle chuck 404. The reticle handler 400 can move in the vertical and horizontal directions to properly align the reticle 402 with the reticle chuck 404. After attachment of the reticle 402, the reticle handler 400 can pull away from the reticle 402 and the reticle chuck 404. The reticle handler 400 can optionally pick up the top plate 410 from the support structure 430. The reticle handler 400 can also maneuver the end-effector 408 into a cooling unit for cooling.

To ensure thermophoretic protection of the reticle 402 during reticle loading and unloading onto the chuck 404, the temperature of the chuck 404 is also controlled. During reticle loading, the chuck 404 is made colder than the reticle until just before the reticle 402 is attached to the chuck 404. During reticle unloading, the chuck 404 is made colder than the reticle 402 immediately after the reticle 402 is detached from the chuck 404. Upon attachment, the chuck 404 and the reticle 402 should be at approximately the same temperature to avoid any thermal incompatibilities.

In some embodiments, the support structure 382 can include a cooling device for cooling the top plate 378 while the top plate 378 is supported by the support structure 382.

In some embodiments, the reticle 402 can be grounded to the end-effector 408 to prevent contaminants from being attracted towards the reticle 402 by electrostatic forces.

In some embodiments, actuators mounted on reticle handler 200 can be used to move the top plate 410 away to expose the chucking surface 403 of the reticle 402. In this embodiment, the support structure 430 is optional since the top plate 410 can remain attached to the end-effector 408.

In one embodiment of the end-effector 408, the contact points between the top plate 410 and the support structure 430 are made of a magnetic material so that when particles are generated during contact, a magnetic field can be used to draw the particles away from the reticle 402.

FIG. 8 illustrates a side plan, cross-sectional view of a reticle library 500 according to one embodiment of the present invention. Reticle library 500 is useful for storing reticles 502 within a lithography system. The reticle library 500 can also be maintained at the low-pressure environment at which a lithography system is maintained so that the reticles 502 can be quickly and efficiently retrieved for use. Reticle library includes two chambers 504 for storing the respective reticles 502. Walls 506, floors 508, and a ceiling 510 surround the reticles 502. A gate valve 512 seals a side opening to each of chambers 504. The gate valve 512 can be opened and closed to allow a reticle 502 to be inserted and removed from each of the chambers 504. The reticles 502 are supported above the floors 508 by support stems 514. The floors 508 also include a transparent plate 516 that includes one or more light or radiation sources (not shown) for directing light or radiation at each reticle 502. Arrows 518 represent the light or radiation that is directed at the reticles 502. The light or radiation maintains each of the reticles at a temperature that is higher than that of the surrounding walls 506, ceiling 510, floors 508, gate valve 512, and the transparent plates 516. These surrounding structures can also be cooled so to maintain a temperature difference with respect to the reticles 502 to ensure a thermophoretic force region that can protect the reticles 502 from contamination.

In an alternative embodiment, light or radiation sources can be positioned above and to the side of the reticle 502 as well as below the reticle. Other embodiments of the reticle library 500 can include different numbers of chambers 504. In some embodiments, the reticles 502 can be electrically grounded to their surroundings, such as the walls 506 and the floors 516. In some embodiments gate valve 512 is optional. In some embodiments, the reticle can be heated by heaters around the reticle perimeter, through convection or radiation, without contact—similar to the pod approach.

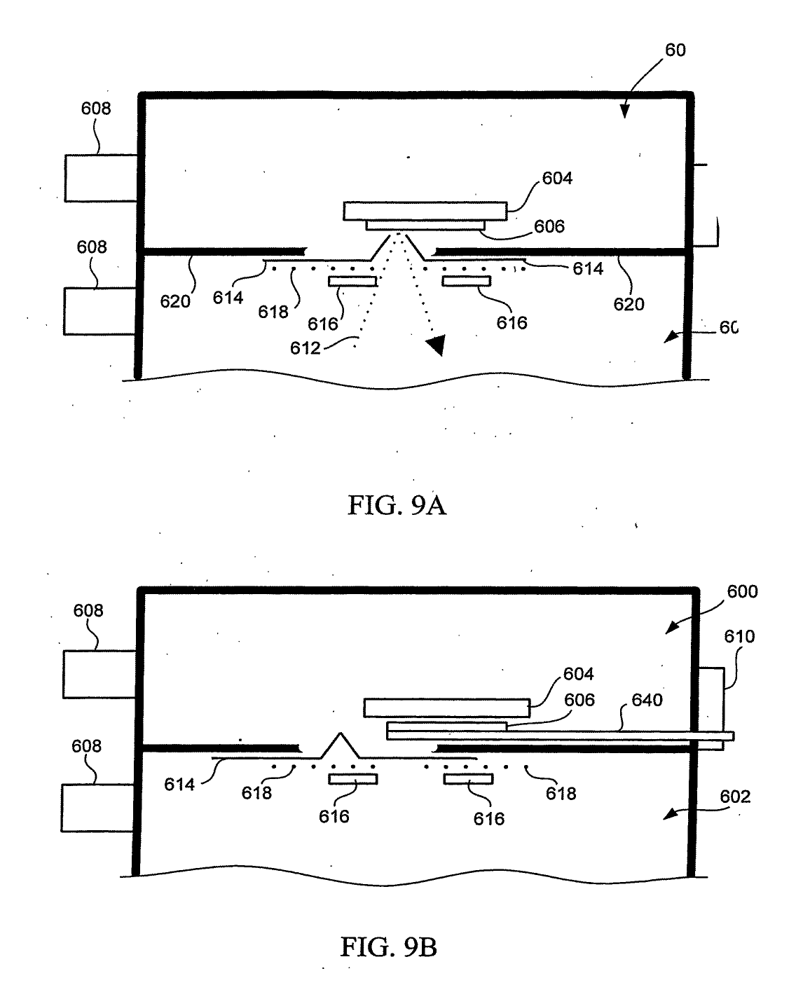

FIG. 9A illustrates a reticle stage (RS) chamber 600 and a projection optics (PO) chamber 602 according to one embodiment of the present invention. The RS chamber 600 and the PO chamber 602 act to protect the reticle 606 from contaminants during an exposure process through thermophoresis. The RS chamber 600 houses a reticle stage (not shown) to which is attached a reticle chuck 604 and a reticle 606 while the reticle 606 is used for projecting a pattern of light onto a substrate such as a semiconductor wafer. Typically, the reticle is clamped to the chuck with an electrostatic force generated by the chuck. A vacuum pump 608 is connected to the reticle chamber 600 to maintain the desired pressure level within the chamber. A gate valve 610 is formed on a side surface of the retcile chamber 600 so that the reticle 606 can be inserted and removed from the chamber. The projection optics chamber 602 houses the optical system that directs light, for example, extreme ultraviolet light (EUV), upon the reticle 606. The optical system is not shown, however the light 612 is shown being directed towards the reticle 606 and reflecting off the reticle 606. The reflected light 612 is directed through the projection optics towards, for example, a semiconductor wafer (which is not shown). Another vacuum pump 608 is also attached to the projection optics chamber 602 to maintain a desired pressure level.

The reticle stage moves the reticle chuck 604 and the reticle 606 from side to side during scanning. Fixed blinds 614 block a portion of the EUV radiation giving the illuminated area on the reticle 606 a specific shape. Moving blinds 616 move from side to side along the scanning direction to block and unblock the aperture during the beginning and the end of the scanning motion.

Thermophoresis is used to protect the reticle 606 from contaminants by maintaining the blinds 614 and 616 and the RS chamber 600 at a lower temperature than the reticle 606, thereby generating a thermophoretic force region between the reticle 606 and its surroundings and protecting the reticle 606 from particle contamination. Additionally, the thermophoretic effect is implemented by using the fixed blinds 614 and/or the moving blinds 616 to form a low conductance gas path between the PO and RS chambers 600 and 602, respectively, before loading and unloading of the reticle 606. This allows the pressure in RS chamber 600 to be adjusted to provide adequate thermophoretic protection while allowing a different pressure in PO chamber 602.

The reticle is maintained at a higher temperature than its surroundings by heating elements in the chuck 604. In addition, reticle 606 can be heated by the EUV radiation, and/or can be heated by an external heating means in the RS chamber 600. The surroundings, such as the RS chamber 600, fixed 614 and moving blinds 616 can be kept cool by conductive or radiative cooling. Because the EUV radiation will also tend to heat the fixed blinds, heat shields 618 can be located beneath the fixed blinds 614.

A thermophoretic force region is established between the warmer reticle 606 and its colder surroundings. Particles in this force region will move away from the reticle 606 and towards the colder surfaces, hence protecting the reticle 606 from particles. Because thermophoresis requires a gas medium, the RS chamber 600 is maintained at a pressure level that is equal to or above a low vacuum. Note that gas mediums absorb EUV radiation, and this absorption is proportional to the gas pressure. For this reason it is necessary to minimize the gas pressure where possible along the beam path of the EUV radiation. To this effect, the pressure within the PO chamber 602 is maintained at a lower pressure than that within the RS chamber 600. For efficient use of the available vacuum pumps 608, it is necessary to minimize the gas conductance between the PO chamber 602 and RS chamber 600. Gas conductance is minimized by minimizing the distance between the top edge of the fixed blind 614 and the reticle 606 and by minimizing the distance between the fixed blind 614 and the chamber walls 620 (during scanning). In one embodiment, the RS chamber 600 is maintained at approximately 25-50 mTorr and the PO chamber 602 is maintained at approximately 5 mTorr. Other techniques of thermophoretic protection of the reticle 606 in RS chamber 600 are described in U.S. patent application Ser. No. 10/898,475, filed on Jul. 23, 2004, entitled “Extreme Ultraviolet Reticle Protection Using Gas Flow Thermophoresis.”

FIG. 9B illustrates the RS chamber 600 and the PO chamber 602 while an end-effector 640 enters the RS chamber 600 to remove the reticle 606. As shown in FIG. 9B, before the side gate valve 610 is opened to either load or unload the reticle 606, the two halves of the fixed blinds 614 move towards one another and close upon the fixed blind aperture to form a low conductance gas path. In other words, the fixed blinds 614 serve to seal the RS chamber 600 from the PO chamber 602. This closing of the aperture allows the vacuum pumps to efficiently maintain the respective chamber vacuums during reticle loading and unloading, preventing pressure equalization in the chambers which would harm system productivity as additional time would be required to regain pressure difference. Note that the gas inlets to the chambers are not shown. In another embodiment, a movable shutter covers the fixed blind aperture during reticle loading and unloading, thereby maintaining a low conductance between RS chamber 600 and PO chamber 602.

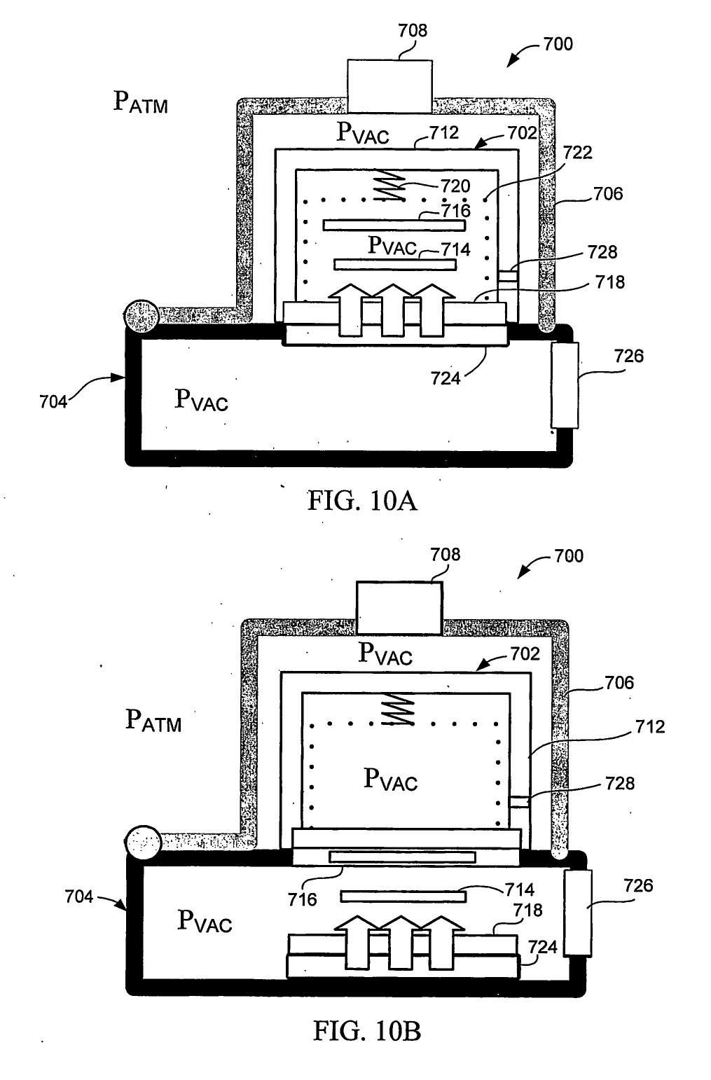

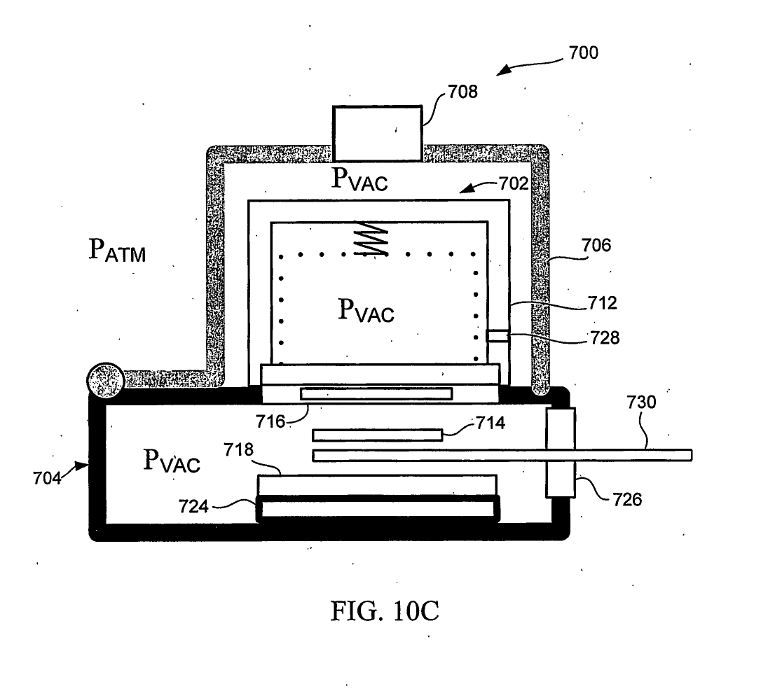

FIGS. 10A-10C illustrate a reticle depod and interlock (DI) unit 700 according to one embodiment of the present invention. The depod/interlock unit is used to depressurize/pressurize and to open/close a reticle pod. The DI unit 700 includes a reticle pod 702, a depod chamber 704, a lid 706, and a vacuum pump 708. The reticle pod 702 includes a cover 712, a reticle 714, a top plate 716, a bottom plate 718, a filter spring, 720, and a filter 722. The lid 706 is attached to the depod chamber 704 and seals the reticle pod 702 onto a top surface of the depod chamber 704. The vacuum pump 708 is attached to the lid 706 and is capable of lowering the pressure within the lid 706. The depod chamber 704 includes a top gate valve 724 and a side gate valve 726.

The reticle pod 702 is placed on to the top gate valve 724 by a pod handler or by a human, and the bottom plate 718 of the reticle pod 702 is automatically locked to the top gate valve 724. The lid 706 is automatically closed over the reticle pod 702 and the vacuum pump 708 depressurizes the area between the lid 706 and reticle pod 702. The lid 706 can be made of any suitable material that is able to contain a vacuum pressure level. The pressure inside and outside of the pod is always substantially equal due to the equalization port 728 located in the cover 712 of the reticle pod 702. The pressure equalization prevents excessive differential forces on the cover 712. The equalization port 728 allows the cover 712 to be made of material that does not necessarily have to withstand a differential pressure where a vacuum pressure is contained within.

Once the reticle pod 702 and its surroundings have been depressurized, the top gate valve 724 automatically lowers while at the same time opening the reticle pod 702. See FIG. 10B, which illustrates a side plan, cross-sectional view of the DI unit 700 after the bottom plate 718 is lowered into the depod chamber 704.

FIG. 10C illustrates a side plan, cross-sectional view of an end-effector 730 that enters through the side gate valve 726 to remove the reticle 714.

The reticle pod 702 is shown to have the top plate 716 and the bottom plate 718 that can thermophoretically protect the reticle 714. However, in alternative embodiments, the reticle pod 702 does not utilize thermophoretic protection of the reticle 714.

Electrical devices may be provided to ensure that the reticle 714 and adjacent surfaces remain electrically grounded during operation of DI unit 700.

In an alternative embodiment, the reticle pod 702 is formed of a material that can withstand a differential pressure where a vacuum is created within the cover 712. In this embodiment, the lid 706 is not needed and a vacuum need not be pulled under the lid 706.

In some embodiments, a pre-alignment system is placed within the depod chamber 704 to measure the position of the reticle 714 relative to the end-effector 730 that will handle the reticle 714. This obviates the need to have a separate pre-alignment chamber within a lithography system and thereby reduces the footprint of the lithography system.

Note that thermophoretic protection of reticles can be used throughout many of the processes for using a reticle 714 within a lithography system. For example, a pair of plates can be placed above and below a reticle in each of the processes where feasible.

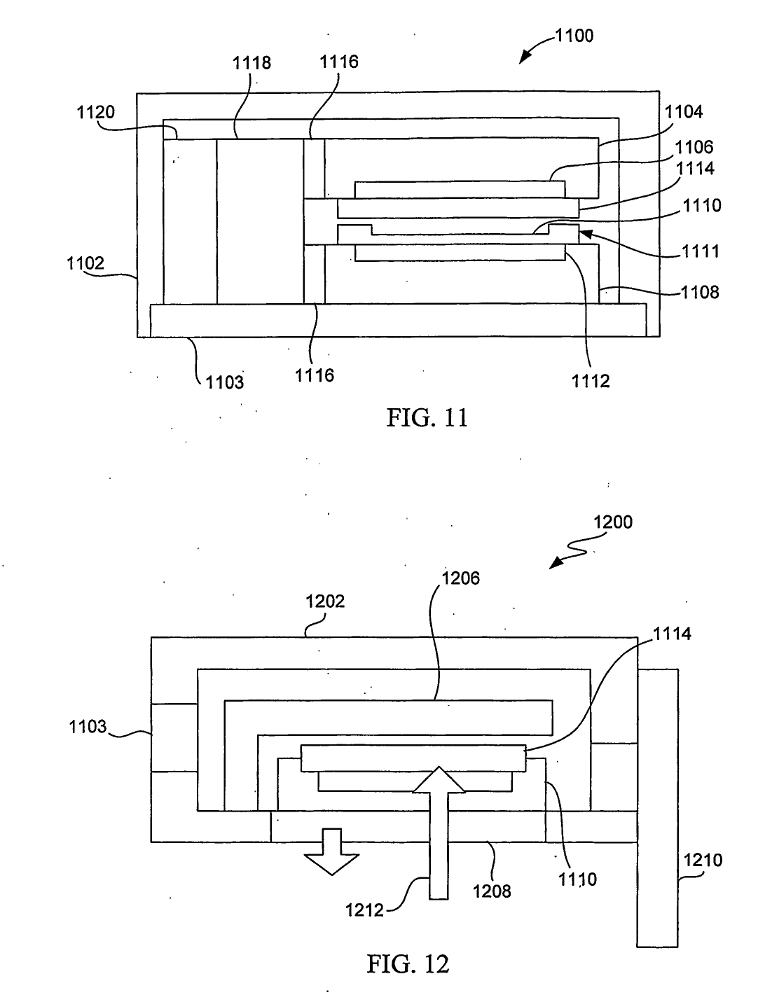

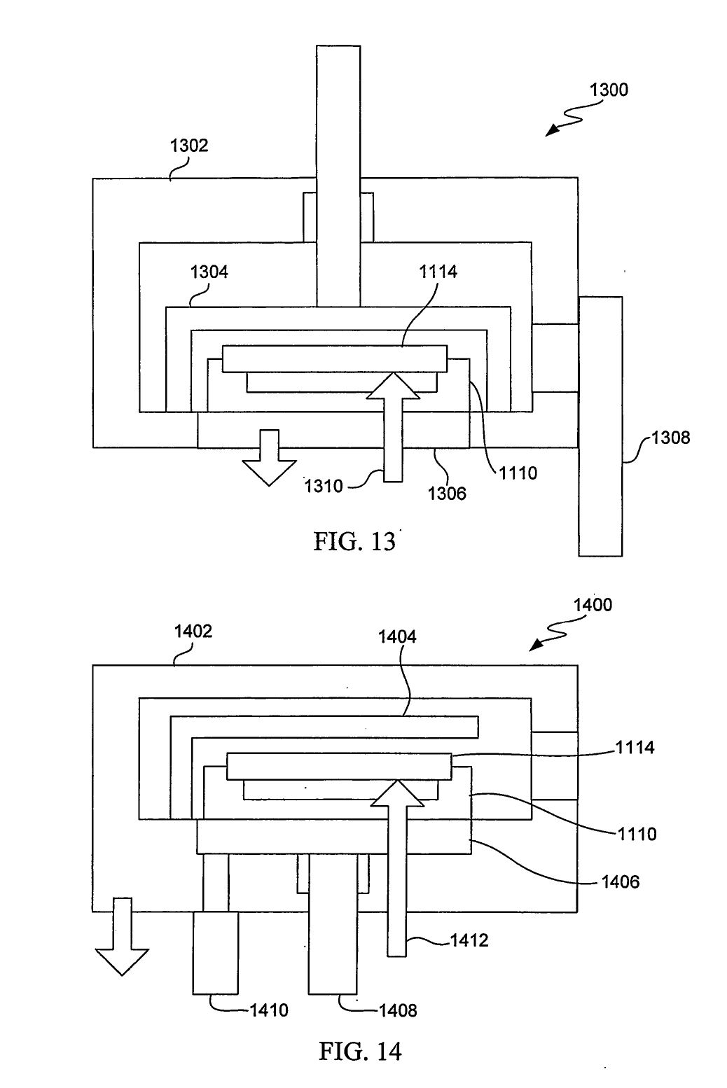

FIGS. 11-14 describe alternative embodiments of the present invention that utilize a removable cover 1110. Removable cover 1110 is a protective cover that can be placed over and protectively seal the patterned surface of a reticle. In some embodiments, removable cover 1110 has an outer rim 1111 that comes into contact and attaches to a reticle. Note that outer rim 1111 can have various shapes and sizes suitable for attaching to a reticle. According to the spirit of the present application, the removable cover 1110 can also be maintained at a lower temperature relative to a reticle so to provide the reticle thermophoretic protection from contaminating particles. FIGS. 11-14 illustrate the use of removable cover 1110 in various subsystems of an EUVL system. FIG. 11 pertains to a reticle pod 1100, FIG. 12 pertains to an interlock 1200, FIG. 13 pertains to a reticle library 1300, and FIG. 14 pertains to a reticle pre-alignment system 1400. Note that the removable cover can be used in various portions of a photolithography system that are not necessarily limited to those presented in FIGS. 11-14.

FIG. 11 illustrates a cross-sectional view of a reticle pod 1100 that includes a removable cover 110 according to one embodiment of the present invention. Reticle pod 1100 includes a cover 1102, a base 1103, an upper plate 1104 that supports an upper electrostatic chuck 1106, a lower plate 1108 that supports a lower electrostatic chuck (ESC) 1112, a reticle 1114 that is attached to the upper electrostatic chuck (FSC) 1106, heat pumps 1116, a support structure 1118, and a heat exchanger 1120. The reticle pod 1100 protects the reticle 114 during storage and transport outside of a lithography tool, such as an EUVL system. Reticle pod 1100 may utilize one or more contaminant protection techniques such as thermophoresis, electrical grounding, removable cover 1110, and a upper plate 1104, which protects the backside of reticle 1114.

The reticle 1114 is held in reticle pod 1100 by an electrostatic chucking force exerted by the upper electrostatic chuck 1106. The ESC's 1106 and 112 are used to prevent the reticle 1114 and removable cover 1110 from moving around during shipping, as movement can cause damage to the reticle 1114 and removable cover 1110 and generate unwanted particles within the reticle pod 1100 and on the reticle 1114 and removable cover 1110.

ESC's 1106 and 1112 typically have flat surfaces to minimize particle generation during clamping of the reticle 1114 to the upper ESC 1106 and clamping of the removable cover 1110 to the lower ESC 1112. An ESC with a flat topography can maximize clamping force. The ESC's 1106 and 1112 are also used to conductively transfer heat between the reticle 1114, removable cover 1111, and respective upper and lower plates 1104 and 1108. A temperature difference between the reticle 1114 and removable cover 1110 generates a thermophoretic pressure gradient within the gas between the reticle 1114 and removable cover 1110. Particles are driven by this thermophoretic pressure gradient towards the cooler surface, thereby protecting the reticle 1114 from particle contamination.

Additionally, the small gap between the reticle 1114 and removable cover 1110 is kept relatively small (approximately a few millimeters) to reduce particle migration between surroundings and the reticle 1114 from random gas motion and turbulence during pressure changes. Additionally, airborne particles cannot migrate to the backside of the reticle 1114 because there is no gap between the reticle backside and upper ESC 1106.

Removable cover 1110 serves two purposes. The first is to reduce particle generation at the reticle 1114 surface by contact events because a reticle handler handles the reticle 1114 indirectly via the removable cover 1110. The second purpose is that thermophoresis continues between the removable cover 1110 and reticle 1114 during transport because of the inherent thermal capacity of the removable cover 1110. Thirdly, the removable cover 1110 protects the front (or patterned) surface of reticle 1114 even when thermophoresis is not used (i.e. in high vacuum, where thermophoresis is in effective).

Reticle 1114 backside can be protected during handling with the addition of a cooler plate above the reticle 1114 backside. This cooler plate can extend along the reticle path or it can be a part of a handler end-effector. The gap between such a warmer plate and the reticle 1114 backside is kept relatively small (as explained previously).

The reticle 1114 is warmed by conduction via ESC 1106, upper plate 1104 and heat pump 1116. Temperature sensors (not shown) in the upper plate 1104 are used to sense the reticle 1114 temperature. The removable cover 1110 is cooled by conduction via lower ESC 1112, lower plate 1108, and heat pump 1116. Temperature sensors (not shown) in the lower plate 1108 are used to sense the removable cover 1110 temperature. A temperature controller (not shown) may be located in the support structure 1118. Heat is pumped in and out of the support structure 1118 as required to maintain the proper reticle 1114 and removable cover 1110 temperatures. Heat is transferred away from the support structure 1118 to the pod cover 1102 via heat exchanger 1120. The heat is transferred via heat exchanger 1120 through convection and/or radiation. These non-contact methods are used so that particles are not generated during pod-opening processes. When pod cover 1102 and support structure 1118 make (normal and non-sliding) contact on top of support structure 1118 (in another embodiment, not shown), then conductive heat transfer between the pod cover 1102 and support structure 1118 can occur with minimal particle generation. However, the non-contact approach is advantageous because no particles are generated between pod cover 1102 and support structure 1118 during pod opening and closing. Also, after the reticle 1114 is removed from reticle pod 1100, the temperature gradient between the top and bottom ESC's 1106 and 1112 provides thermophoretic protection of the top ESC 1106, ensuring a clean chucking surface.

Electrical grounding is used between the reticle 1114, removable cover 1110, and upper 1104 and lower 1108 plates to eliminate undesirable electric fields between the reticle 1114 and its surroundings. Therefore, the reticle 1114 and its surroundings must also be made of a conductive material or have a conductive coating. A dielectric in the ESC's 1106 and 1112 insulates the ESC electrodes from the reticle 1114 and removable cover 1110.

The pod 1100 can be powered by a power supply in the module and/or a battery in/on the pod 1100. A communication link may also be made between the pod controller and module for diagnostics, monitoring, and more advanced process control.

In an alternative embodiment, a removable cover can be attached to the top or chucking surface of reticle 1114. This removable cover, which can be referred to as a “top” removable cover in contrast to the removable cover 1110 that covers the bottom and patterned surface of reticle 1114, protects the chucking surface of reticle 1114 from contamination. The top removable cover can be attached to and removed from the top ESC 1106. The reticle 1114 can then be secured between a top and a bottom removable cover, which are each respectively attached to top and bottom ESC's 1106 and 1112. The reticle 1114 can be removed from reticle pod 1100 while be protected by top and bottom removable covers, which can be removed from reticle 1114 when necessary.

FIG. 12 illustrates a cross-sectional view of an interlock chamber 1200 that includes a removable cover 1110 according to one embodiment of the present invention. Interlock chamber 1200 protects the reticle 1114 from particle contamination during pressure transitions. Interlock chamber 1200 includes a reticle 1114 that is attached to a removable cover 1110, a chamber wall 1202 that includes a filter port 1204, an inner shell 1206, a chamber base 1208, and a gate valve 1210.

A temperature difference between the reticle 1114 and its surroundings generates a thermophoretic pressure gradient within the gas between the reticle 1114 and its surroundings. Particles are driven by this thermophoretic pressure gradient towards the cooler surface, thereby protecting the reticle 1114 from particle contamination. Additionally, the gap between the reticle 1114 and surroundings is kept relatively small (e.g., approximately a few millimeters) to reduce particle migration between surroundings and the reticle 1114 from random gas motion and turbulence during pressure changes.

The reticle 1114 may be warmed by various means (such as eddy current, resistive heating, radiation). In this embodiment the reticle 1114 is warmed by radiation. Therefore, the interlock chamber 1200 and removable cover 1110 are made of transparent material to allow for the transmission of radiation 1212 to the reticle 1114. The interlock chamber 1200 and removable cover 1110 can be cooled conductively or convectively with an external cooling device.

Electrical grounding can be used between the reticle 1114 and its surroundings to eliminate undesirable electric fields between the reticle 1114 and its surroundings. Therefore, the reticle 1114 and its surroundings must also be made of a conductive material, or have a conductive coating.

In an alternative embodiment, a removable cover that covers the top or chucking surface of reticle 1114 can be utilized as described above with respect to FIG. 11.

FIG. 13 illustrates a reticle library 1300 that includes a removable cover 1110 according to one embodiment of the present invention. Reticle library 1300 is design to protect the reticle 1114 from particle contamination during storage in vacuum. Reticle library 1300 includes a reticle 1114 that is attached to a removable cover 1110, a chamber wall 1302, a cover 1304, a chamber base 1306, and a gate valve 1308. Cover 1304 protects the reticle 1114 in the event of an accidental venting of the reticle library 1300.

A temperature difference between the reticle 1114 and its surroundings generates a thermophoretic pressure gradient within the gas between the reticle and its surroundings. Particles are driven by this thermophoretic pressure gradient towards the cooler surface, thereby protecting the reticle 1114 from particle contamination. Additionally, the gap between the reticle 1114 and surroundings is kept relatively small (e.g., approximately a few millimeters) to reduce particle migration between surroundings and the reticle 1114 from random gas motion and turbulence during pressure changes.

The reticle 1114 may be warmed by various means (such as eddy current, resistive heating, radiation). In this embodiment, the reticle is warmed by radiation. Therefore, the reticle library 1300 and removable cover 1110 are made of transparent material to allow for the transmission of radiation 1310 to the reticle 1114. The reticle 1300 library and removable cover 1110 can be cooled conductively or convectively with an external cooling devices.

In some embodiments, electrical grounding is used between the reticle 1114 and its surroundings to eliminate undesirable electric fields between the reticle 1114 and its surroundings. Therefore, the reticle 1114 and its surroundings must also be made of a conductive material or have a conductive coating.

In an alternative embodiment, a removable cover that covers the top or chucking surface of reticle 1114 can be utilized as described above with respect to FIG. 11.

FIG. 14 illustrates a cross-sectional view of a reticle pre-alignment system 1400 that includes a removable cover 1110 according to one embodiment of the present invention. Reticle pre-alignment system 1400 is designed to protect the reticle 1114 from particle contamination during pre-alignment. Reticle pre-alignment is required to position the reticle 1114 such that reticle 1114 is within a capture range of the onstage alignment system when delivered to a stage by a reticle handler.

Reticle pre-alignment system 1400 includes a chamber wall 1402, a reticle 1114 that is attached to a removable cover 1110, an inner shell 1404, an actuated table 1406 that is attached to an actuator 1408, and a camera 1410.

Thermophoresis is used to protect reticle 1114 from contaminants by maintaining reticle 1114 at a higher temperature than the surrounding components of removable cover 1110, inner shell 1404, actuated table 1406, and chamber wall 1402. Radiation 1412 from a radiation source (not shown) is directed upon reticle 1114 to maintain reticle 1114 at an elevated relative temperature. Pre-alignment chamber 1400 and removable cover 1110 can be made of transparent material to allow for the transmission of radiation 1412 to the reticle 1114. Reticle 1114 may be warmed by various means (such as eddy current, resistive heating, radiation). Chamber wall 1402, removable cover 1110, actuated table 1406, and inner shell 1404 can be cooled conductively or convectively with an external cooling devices.

In an alternative embodiment, a removable cover that covers the top or chucking surface of reticle 1114 can be utilized as described above with respect to FIG. 11.

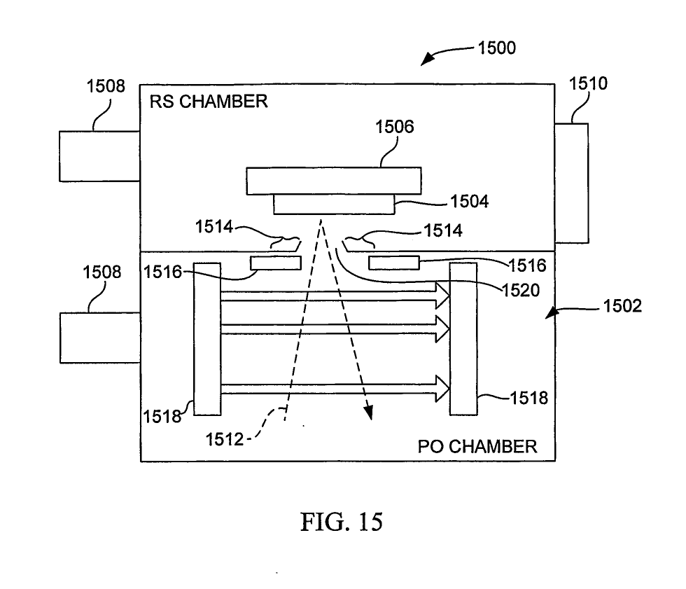

FIG. 15 illustrates a reticle stage (RS) chamber 1500 and a projection optics (PO) chamber 1502 according to one embodiment of the present invention. The RS chamber 1500 and the PO chamber 1502 act to protect the reticle 1504 from contaminants during an exposure process through thermophoresis. The RS chamber 1500 houses a reticle stage (not shown) to which is attached a reticle chuck 1506 and a reticle 1504 while the reticle 1504 is used for projecting a pattern of light onto a substrate such as a semiconductor wafer. Typically, the reticle is clamped to the chuck with an electrostatic force generated by the chuck. A vacuum pump 1508 is connected to the reticle chamber 1500 to maintain the desired pressure level within the chamber. A gate valve 1510 is formed on a side surface of the retcile chamber 1500 so that the reticle 1504 can be inserted and removed from the chamber. The projection optics chamber 1502 houses the optical system that directs light, for example, extreme ultraviolet light (EUV), upon the reticle 1504. The optical system is not shown, however the light 1512 is shown being directed towards the reticle 1504 and reflecting off the reticle 1504. The reflected light 1512 is directed through the projection optics towards, for example, a semiconductor wafer (which is not shown). Another vacuum pump 1508 is also attached to the projection optics chamber 1502 to maintain a desired pressure level.

FIG. 15 illustrates an alternative embodiment of the invention that is directed towards protecting reticle 1504 on a stage electrostatic chuck 1506 from particles in an EUV lithography tool. Thermophoresis is used to protect the reticle 1504 from particles. The reticle 1504 is maintained at a warmer temperature than the fixed blinds 1514 and the moving blinds 1516, so particles are driven towards the fixed blinds 1514 and moving blinds 1516 by thermophoresis. Also, the structure around the aperture 1520 provides a mechanical barrier against particles originating in the PO chamber 1502 and acts like a pellicle.

An aperture 1520 is created within the opening between the moving blinds 1516. Because the moving blinds 1516 do not always cross the aperture 1520, an additional protection means is required to protect particles from reaching the reticle through the aperture 1520. Therefore, an electrophoretic or photophoretic force field can be used to drive particles away from the front of the aperture 1520. Electrodes 1518 are positioned within the PO chamber 1502 and on opposing sides of the aperture 1520. The electrodes 1518 can create the electrophoretic field for driving particles away from the aperture 1520. In an alternative embodiment, one of the electrodes 1518 is actually a light source and the other electrode 1518 is a light sink for creating the photophoretic field. Grounding the reticle 1504 and its immediate surroundings prevents unwanted electric fields from terminating at the reticle 1504 and prevents particle migration towards the reticle 1504 via stray electric fields. The aperture 1520 between the fixed blinds 1514 is also grounded and shaped to prevent electric fields generated by electrodes from terminating on reticle 1504, which prevents particle migration towards the reticle 1504 via stray electric fields.

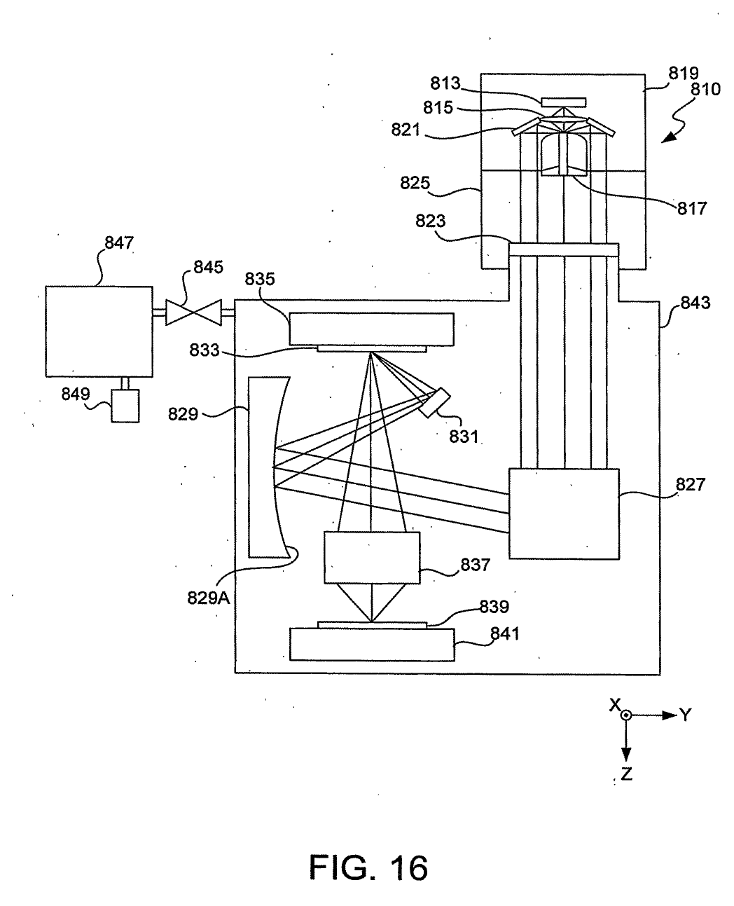

FIG. 16 shows an EUV (or soft-X-ray SXR) system 810, including the EUV mirror of this invention as described above. As a lithographic energy beam, the EUV system 810 uses a beam of EUV light of wavelength λ=13 nm. The depicted system is configured to perform microlithographic exposures in a step-and-scan manner.

The EUV beam is produced by a laser-plasma source 817 excited by a laser 813 situated at the most upstream end of the depicted system 810. The laser 813 generates laser light at a wavelength within the range of near-infrared to visible. For example, the laser 813 can be a YAG laser or an excimer laser. Laser light emitted from the laser 813 is condensed by a condensing optical system 815 and directed to the downstream laser-plasma source 817. Upon receiving the laser light, the laser-plasma source 817 generates SXR (EUV) radiation having a wavelength (λ) of approximately 13 nm with good efficiency.

A nozzle (not shown), disposed near the laser-plasma source 817, discharges xenon gas in a manner such that the discharged xenon gas is irradiated with the laser light in the laser-plasma source 817. The laser light heats the discharged xenon gas to a temperature sufficiently high to produce a plasma that emits photons of EUV light as the irradiated xenon atoms transition to a lower-potential state. Since EUV light has low transmittance in air, the optical path for EUV light propagating from the laser-plasma source 817 is contained in a vacuum chamber 819 normally evacuated to high vacuum. Since debris normally is produced in the vicinity of the nozzle discharging xenon gas, the vacuum chamber 819 desirably is separate from other chambers of the system.

A parabolic mirror 821, coated with a Mo/Si multilayer film, is disposed relative to the laser-plasma source 817 so as to receive EUV light radiating from the laser-plasma source 817 and to reflect the EUV light in a downstream direction as a collimated beam. The multilayer film on the parabolic mirror 821 is configured to have high reflectivity for EUV light of which λ=approximately 13 um.

The collimated beam passes through a visible-light-blocking filter 823 situated downstream of the parabolic mirror 821. By way of example, the filter 823 is made of Be, with a thickness of 0.15 nm. Of the EUV radiation reflected by the parabolic mirror 821, only the desired 13-nm wavelength of radiation passes through the filter 823. The filter 823 is contained in a vacuum chamber 825 evacuated to high vacuum.

An exposure chamber 843 is disposed downstream of the filter 823. The exposure chamber 843 contains an illumination-optical system 827 that comprises a condenser mirror and a fly-eye mirror (not shown, but well understood in the art). The illumination-optical system 827 also is configured to trim the EUV beam (propagating from the filter 823) to have an arc-shaped transverse profile. The shaped “illumination beam” is irradiated toward the left in the figure.

A circular, concave mirror 829 is situated so as to receive the illumination beam from the illumination-optical system 827. The concave mirror 829 has a parabolic reflective surface 829a and is mounted perpendicularly in the vacuum chamber 843. The concave mirror 829 comprises, for example, a quartz mirror substrate of which the reflection surface is machined extremely accurately to the desired parabolic configuration. The reflection surface of the mirror substrate is coated with a Mo/Si multilayer film so as to form the reflective surface 829a that is highly reflective to EUV radiation of which λ=13 nm. Alternatively, for other wavelengths in the range of 10-15 nm, the multilayer film can be of a first substance such as Ru (ruthenium) or Rh (rhodium) and a second substance such as Si, Be (Beryllium) or B₄C (carbon tetraboride).

A mirror 831 is situated at an angle relative to the concave mirror 829 so as to receive the EUV beam from the concave mirror 829 and direct the beam at a low angle of incidence to a reflective reticle 833. The reticle 833 is disposed horizontally so that its reflective surface faces downward in the figure. Thus, the beam of EUV radiation emitted from the illumination-optical system 827 is reflected and condensed by the concave mirror 829, directed by the mirror 831, and focused on the reflective surface of the reticle 833.

The reticle 833 includes a multilayer film so as to be highly reflective to incident EUV light. A reticle pattern, corresponding to the pattern to be transferred to a substrate 839, is defined in an EUV-absorbing layer formed on the multilayer film of the reticle 833, as discussed later below. The reticle 833 is mounted via a reticle chuck on a reticle stage 835 that moves the reticle 833 at least in the Y direction. The reticle 833 normally is too large to be illuminated entirely during a single exposure “shot” of the EUV beam. As a result of the mobility of the reticle stage 835, successive regions of the reticle 833 can be irradiated sequentially so as to illuminate the pattern in a progressive manner with EUV light from the mirror 831.

A projection-optical system 837 and substrate (such as a semiconductor wafer) 839 are disposed in that order downstream of the reticle 833. The projection-optical system 837 comprises multiple multilayer-film reflective mirrors that collectively demagnify an aerial image of the illuminated portion of the pattern on the reticle 833. The demagnification normally is according to a predetermined demagnification factor such as ¼. The projection-optical system 837 focuses an aerial image of the illuminated pattern portion onto the surface of the substrate 839. Meanwhile, the substrate 839 is mounted via a wafer (substrate) chuck on a substrate stage 841 that is movable in the X, Y, and Z directions.

Connected to the exposure chamber 843 via a gate valve 845 is a preliminary-evacuation (“load-lock”) chamber 847. The load-lock chamber 847 allows exchanges of the reticle 833 and/or substrate 839 as required. The load-lock chamber 847 is connected to a vacuum pump 849 that evacuates the load-lock chamber 847 to a vacuum level substantially equal to the vacuum level inside the exposure chamber 843.

During a microlithographic exposure, EUV light from the illumination-optical system 827 irradiates the reflective surface of the reticle 833. Meanwhile, the reticle 833 and substrate 839 are moved by their respective stages 835 and 841 in a synchronous manner relative to the projection-optical system 837. The stages 835 and 841 move the reticle 833 and the substrate 839, respectively, at a velocity ratio determined by the demagnification factor of the projection-optical system 837. Thus, the entire circuit pattern defined on the reticle 833 is transferred, in a step-and-scan manner, to one or more “die” or “chip” locations on the substrate 839. By way of example, each “die” or “chip” on the substrate 839 is a square having 25-mm sides. The pattern is thus “transferred” from the reticle 833 to the substrate at very high resolution (such as sufficient to resolve a 0.07-ì m line-and-space (L/S) pattern). So as to be imprintable with the projected pattern, the upstream-facing surface of the substrate 839 is coated with a suitable “resist.”

In the system 810 of FIG. 16 at least one multilayer-film optical element as described above is included in at least one of the illumination-optical system 827, the reticle 833, and the projection-optical system 837.

As described above, a photolithography system according to the above-described embodiments can be built by assembling various subsystems, including each element listed in the appended claims, in such a manner that prescribed mechanical accuracy, electrical accuracy and optical accuracy are maintained. In order to maintain the various accuracies, prior to and following assembly, every optical system is adjusted to achieve its optical accuracy. Similarly, every mechanical system and every electrical system are adjusted to achieve their respective mechanical and electrical accuracies. The process of assembling each subsystem into a photolithography system includes mechanical interfaces, electrical circuit wiring connections and air pressure plumbing connections between each subsystem. Needless to say, there is also a process where each subsystem is assembled prior to assembling a photolithography system from the various subsystems. Once a photolithography system is assembled using the various subsystems, total adjustment is performed to make sure that every accuracy is maintained in the complete photolithography system. Additionally, it is desirable to manufacture an exposure system in a clean room where the temperature and humidity are controlled.

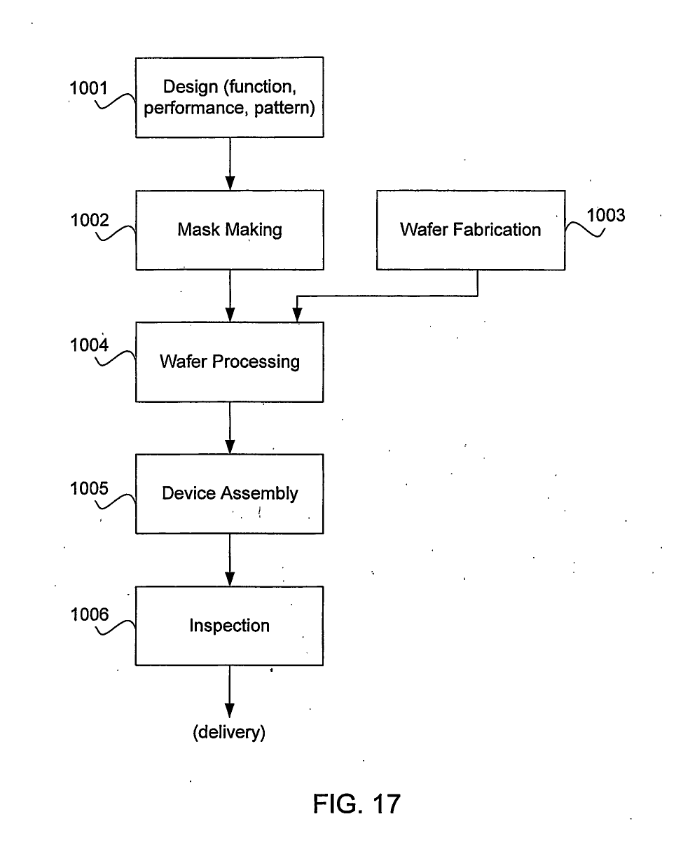

Further, semiconductor devices can be fabricated using the above-described systems, by the process shown generally in FIG. 17. In step 1001 the device's function and performance characteristics are designed. Next, in step 1002, a reticle having a pattern it designed according to the previous designing step, and in a parallel step 1003, a wafer is made from a silicon material. The reticle pattern designed in step 1002 is exposed onto the wafer from step 1003 in step 1004 by a photolithography system such as the systems described above. In step 1005 the semiconductor device is assembled (including the dicing process, bonding process and packaging process), then finally the device is inspected in step 1006.

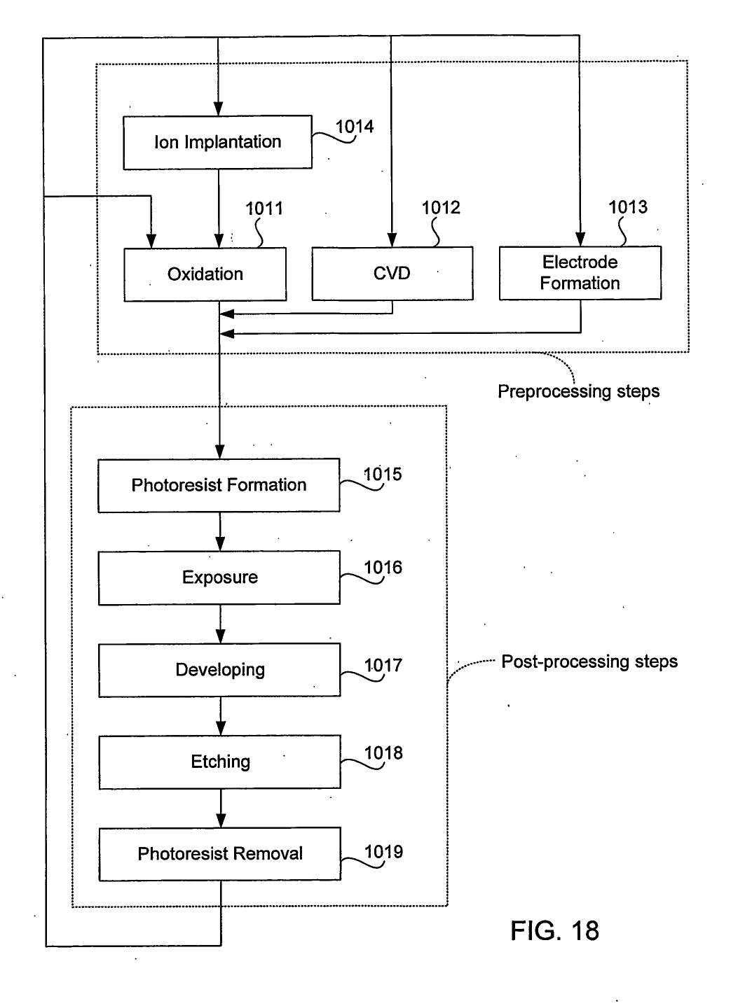

FIG. 18 illustrates a detailed flowchart example of the above-mentioned step 1004 in the case of fabricating semiconductor devices. In step 1011 (oxidation step), the wafer surface is oxidized. In step 1012 (CVD step), an insulation film is formed on the wafer surface. In step 1013 (electrode formation step), electrodes are formed on the wafer by vapor deposition In step 1014 (ion implantation step), ions are implanted in the wafer. The above-mentioned steps 1011-1014 form the preprocessing steps for wafers during wafer processing, and selection is made at each step according to processing requirements.

At each stage of wafer processing, when the above-mentioned preprocessing steps have been completed, the following post-processing steps are implemented. During post-processing, initially, in step 1015 (photoresist formation step), photoresist is applied to a wafer. Next, in step 1016, (exposure step), the above-mentioned exposure device is used to transfer the circuit pattern of a reticle to a wafer. Then, in step 1017 (developing step), the exposed wafer is developed, and in step 1018 (etching step), parts other than residual photoresist (exposed material surface) are removed by etching. In step 1019 (photoresist removal step), unnecessary photoresist remaining after etching is removed. Multiple circuit patterns are formed by repetition of these preprocessing and post-processing steps.

The following U.S. Patents relate to lithography systems and techniques for protecting reticles from contamination and are hereby incorporated by reference for all purposes: 1) U.S. Pat. No. 6,090,176 issued to Yoshitake et al.; 2) U.S. Pat. No. 6,239,863 issued to Catey et al.; 3) U.S. Pat. No. 6,281,510 issued to Yoshitake et al.; 4) U.S. Pat. No. 6,317,479 issued to Chiba et al.; 5) U.S. Pat. No. 6,646,720 issued to Remamoorthy et al.; 6) U.S. Pat. No. 6,728,332 issued to Chiba et al.; 7) U.S. Pat. No. 6,753,945 issued to Heerens et al.; 8) U.S. Patent Application No. 2003/227605 by del Puerto et al.; 9) U.S. Patent Application No. 2004/019408 by del Puerto et al.; and 10) U.S. Patent Application No. 2004/0135987 by Galburt.

While this invention has been described in terms of several preferred embodiments, there are alteration, permutations, and equivalents, which fall within the scope of this invention. It should also be noted that there are many alternative ways of implementing the methods and apparatuses of the present invention. It is therefore intended that the following appended claims be interpreted as including all such alterations, permutations, and equivalents as fall within the true spirit and scope of the present invention.

We claim:

1. An extreme ultraviolet lithography system comprising:
a reticle having a top and a bottom surface;
a plurality of chambers for storing or utilizing the reticle; and
a top plate and a bottom plate that are proximate to the top and bottom surface of the reticle, respectively, the top and bottom plate being maintained at a lower temperature than a temperature of the reticle, wherein the reticle is thermophoretically protected from contamination.

2. A system as recited in claim 1 wherein the top plate and the bottom plate each have a surface area that is at least as large as a surface area of the reticle.

3. A system as recited in claim 1 wherein the bottom plate further comprises:
a plurality of support stems that support the reticle in between the top plate and the bottom plate.

4. A system as recited in claim 1 further comprising:
a reticle handler suitable for transporting the reticle, the reticle handler supporting the top plate and the bottom plate in substantially coplanar relative positions,
the reticle handler supporting the reticle in between the top plate and the bottom plate, wherein the reticle handler transports the reticle while being in between the top plate and the bottom plate so that the reticle is thermophoretically protected from contaminants during transit.

5. A system as recited in claim 2 wherein the top plate is removable from the reticle handler so that the top surface of the reticle can be exposed.

6. A system as recited in claim 1 further comprising:
a pod for storing the reticle, the pod including a cover that can be joined with the bottom plate to enclose the reticle and the top plate within the cover and the bottom plate, wherein the top plate is suspended between the top surface of the reticle and the cover.

7. A system as recited in claim 6 wherein the cover is also maintained at a lower temperature than the temperature of the reticle.

8. A system as recited in claim 6 wherein the bottom plate is transparent, the system further comprising:
a light source that directs light rays through the bottom plate and towards the reticle in order to add heat to the reticle.

9. A system as recited in claim 6 further comprising:
a heating element positioned proximate to an edge of the reticle wherein the heating element adds heat into the reticle.

10. A system as recited in claim 6 further comprising:
an optical power source; and
an optical fiber having a first end that is connected to the optical power source and a second end that is positioned proximate to an edge of the reticle, wherein the optical fiber transfers light from the power source to the edge of the reticle, whereby the light adds heat into the reticle.

11. A system as recited in claim 6 further comprising:
an electrical device connected to the reticle, the electrical device configured to electrically ground the reticle.

12. A system as recited in claim 1 wherein one of the chambers is a storage chamber for storing the reticle, the storage chamber including the top plate and the bottom plate, which are positioned proximate to the top and the bottom surfaces of the reticle, respectively.

13. A system as recited in claim 12 wherein the storage chamber further comprises: side walls and a gate valve that, together with the top and bottom plates, enclose the reticle within the storage chamber, the gate valve being suitable for opening and closing so that the reticle can be inserted and removed from the storage chamber.

14. A reticle handler for transporting a reticle comprising:
a support arm that supports a top plate and a bottom plate in substantially coplanar relative positions such that the reticle can be supported between the top plate and the bottom plate, the top and bottom plate being maintained at a lower temperature than a temperature of the reticle, wherein the reticle handler transports the reticle while being in between the top plate and the bottom plate so that the reticle is thermophoretically protected from contaminants during transit.

15. A reticle handler as recited in claim 14 wherein the top plate and the bottom plate each have a surface area that is at least as large as a surface area of the reticle.

16. A reticle handler as recited in claim 14 wherein the bottom plate further comprises:
a plurality of support stems that support the reticle in between the top plate and the bottom plate.

17. A reticle handler as recited in claim 14 wherein the top plate is removable from the reticle handler so that the top surface of the reticle can be exposed.

18. A reticle handler as recited in claim 14 further comprising:
a cooling unit having a pocket suitable for receiving the top plate and the bottom plate, wherein the cooling unit cools and maintains the top and bottom plates at a relatively low temperature.

19. A pod for storing a reticle comprising:
a top plate and a bottom plate that are suspended in a substantially coplanar orientation relative to each other such that the reticle can be positioned between the top plate and the bottom plate, wherein the top plate and the bottom plate are maintained at a lower temperature than a temperature of the reticle so that the reticle is thermophoretically protected from contamination; and
a cover that joins together with the bottom plate to enclose the reticle and the top plate within the top cover and the bottom plate.

20. A pod as recited in claim 19 wherein the top plate and the bottom plate each have a surface area that is at least as large as a surface area of the reticle.

21. A pod as recited in claim 19 wherein the bottom plate further comprises:
a plurality of support stems that support the reticle in between the top plate and the bottom plate.

22. A pod as recited in claim 19 further comprising:
a filter that sets upon the bottom plate and encloses the top plate and the reticle within the filter and the bottom plate, the filter fitting within the cover and serving to protect the reticle from contaminants.

23. A pod as recited in claim 19 wherein the bottom plate is transparent, the pod further comprising:
a light source that directs light rays through the bottom plate and towards the reticle in order to add heat to the reticle.

24. A pod as recited in claim 19 further comprising:
a heating element positioned proximate to an edge of the reticle wherein the heating element adds heat into the reticle.

25. A pod as recited in claim 19 wherein the bottom plate is a removable cover that is attached to and covers a bottom surface of the reticle.

26. A pod as recited in claim 25 wherein the removable cover is formed of a transparent material.

27. A pod as recited in claim 25 wherein the removable cover is maintained at a lower temperature than a temperature of the reticle so that the reticle is thermophoretically protected from contamination.

28. A pod as recited in claim 25 wherein the removable cover has a cover surface that covers the bottom surface of the reticle wherein a small gap is maintained between the cover surface and the bottom surface of the reticle.

29. A pod as recited in claim 28 wherein the small gap is approximately a few millimeters.

30. A pod as recited in claim 25 further comprising:
a top removable cover that covers a top surface of the reticle.

31. A lithography system comprising:
a reticle chamber that contains a reticle, the reticle being maintained at a reticle temperature, the reticle chamber being maintained at a temperature that is lower than the reticle temperature such that the reticle is thermophoretically protected from contamination; and
an optics chamber that is connected to the reticle chamber through a passageway, the optics chamber containing at least one optical lens for directing ultraviolet radiation through the passageway and towards the reticle.

32. A lithography system as recited in claim 31 further comprising:
a pair of blinds positioned about the passageway, wherein the blinds can separate to leave the passageway open and close to block the passageway.

33. A lithography system as recited in claim 32 wherein the pair of blinds is also maintained at a temperature that is lower than the reticle temperature.

34. A lithography system as recited in claim 31 wherein the reticle chamber is maintained at a low-pressure level, the low-pressure level having a minimum pressure level approximately equal to a low vacuum.

35. A lithography system as recited in claim 34 wherein the optics chamber is maintained at a pressure level that is lower than the pressure level maintained in the reticle chamber.

36. A lithography system as recited in claim 32 further comprising:
a pair of heat shields wherein each heat shield covers and protects a respective one of the blinds from heat absorbed from the ultraviolet radiation.

37. A lithography system comprising:
a pod suitable for containing a reticle;
a loadlock chamber having a first surface that contains a first gate valve, wherein the pod is attached to the first surface of the loadlock chamber, and wherein the first gate valve allows the reticle to be transferred from the pod into the loadlock chamber; and
a lid that seals the pod between the lid and the first surface of the loadlock chamber such that a low pressure environment can be formed around the pod.

38. A lithography system as recited in claim 37 wherein the loadlock chamber further comprises:
a second gate valve that can be selectively opened to allow a reticle handler to transport a reticle into and out of the loadlock chamber.

39. A lithography system as recited in claim 37 wherein the pod has an equalization port that allows for pressure equalization between an inside volume of the pod and a volume outside of the pod.

40. A lithography system comprising:
an illumination source;
an optical system;
a reticle stage;
a working stage arranged to retain a workpiece;
an enclosure that surrounds at least a portion of the working stage, the enclosure having a sealing surface;
a reticle having a top and a bottom surface; and
a top plate and a bottom plate that are proximate to the top and bottom surface of the reticle, respectively, the top and bottom plate being maintained at a lower temperature than a temperature of the reticle, wherein the reticle is thermophoretically protected from contamination.

41. An object manufactured with the lithography system of claim 40.

42. A wafer on which an image has been formed by the lithography system of claim 40.

43. A method for making an object using a lithography process, wherein the lithography process utilizes a lithography system as recited in claim 40.

44. A method for patterning a wafer using a lithography process, wherein the lithography process utilizes a lithography system as recited in claim.
